(19) United States
(12) Patent Application Publication
(10) Pub. No.: US 2003/0220796 A1
(43) Pub. Date: Nov. 27, 2003

(54) Dialogue control system, dialogue control method and robotic device

(76) Inventors: Kazumi Aoyama, Saitama (JP); Hideki Shimomura, Kanagawa (JP); Keiichi Yamada, Tokyo (JP)

Correspondence Address: William S. Frommer, Esq., FORMMER LAWRENCE & HAUG LLP, 745 Fifth Avenue, New York, NY, 10151, US

(21) Appl. No.: 10/379,440

(22) Filed: Mar. 4, 2003

(30) Foreign Application Priority Data
Mar. 6, 2002 (JP) 2002-060428

(51) Int. Cl. G10L 21/00

(52) U.S. Cl. 704/275

(57) ABSTRACT

A dialogue control system, a dialogue control method and a robotic device are capable of remarkably improving the entertainment factor. In the dialogue control system in which a robot and the information processing device are connected via the network, in the case of conducting the conversation by word games between the robot and the user, the history data regarding the word game in said user's speech content is formed and transmitted to the information processing device. Then, said information processing device selectively reads out the contents best suited to the user based on said history data from the memory means and provides to the original robot.

### BACKGROUND OF THE INVENTION

1. Field of the Invention

The present invention relates to a dialogue control system, a dialogue control method and a robotic device and is suitably applicable to such as an entertainment robot.

2. Description of the Related Art

Entertainment robots for general households have been developed and commercialized in many companies in recent years. Some of these entertainment robots are equipped with various external sensors such as a charge coupled device (CCD) camera and a microphone, and these can recognize the external conditions based on these external sensors and can function automatically based on such recognition.

In the case of constructing the audio interactive system in which a robot and the user conduct the audio conversation, an audio interactive system aimed at accomplishing some task, such as receiving the telephone shopping, and informing the telephone number, can be considered.

Assuming the scene in which the daily conversation is conducted between a robot and a man, the robot should come up in conversation such as gossip talk and playing on words, i.e., the conversation that would not be tiring even if it is conducted every day, in addition to the dialogue just to accomplish his task. However, in the interactive system aimed at accomplishing such task, since the data such as the telephone number list and the shopping item list in the system were fixed to the specific contents, the conversation of the robot could not have fun. And furthermore, the data in said system could not be changed according to the taste of a person who was using said system.

Especially, in the case where the robot and the man conduct the conversation by playing on words, such as giving a riddle and Yamanote-line game (the game to exchange words having contents related to the specific item not repeating the same word each other) as the daily conversation, it is necessary for the robot to hold a large volume of data showing the conversation contents (hereinafter referred to as content data).

In recent years, Web (i.e., World Wide Web: WWW), an information net that made various kinds of documents among servers distributed on the Internet searchable connecting each form of document, has been widely used as an information service. And using such Web, the content server having a large volume of contents exchanges the content data to be held by the robot exchanging the content data among robots, and thus, it is considered that the user facing to said robot can conduct the daily conversation.

Said content server stores database to which all robots capable of using a large volume of content data can access, and reading out content data corresponding to said database as occasion demands, can make the robot utter via the network.

However, in the case of conducting the word game between the robot and the user, the method that the robot acquiring the content data randomly from enormous volume of content data stored in the database cannot satisfy needs of all users since each user has his own taste and the skill to cope with the difficulty is diversified each other.

As a method to solve this problem, the profile information showing the user's taste and his level and classification information having supplemental contents would be stored in the database in advance, and the method that the content server selects the content data associated with the profile information and the classification information when the content server acquires the content data that the user desires from the database in response to the request of the robot can be considered.

However, in the dialogue aiming at the word game such as playing riddles and Yamanote-line game, rhythm and amusingness of the conversation will be required between the robot and the user. However, according to the present speech recognition processing technique, the recognition error to the user's speech cannot be prevented, and if the robot confirms contents of the user's speech in each time, the conversation between the user becomes unnatural.

More specifically, in the case where the user answers “nori (seaweed)” when the robot proposes playing a riddle, “If you eat twice, you will get excited, what's the name of that food?”, if the robot utters as “it's nori” directly confirming, it stops the flow of conversation and at the same time loses amusingness.

On the other hand, if the robot continues the conversation ignoring the contents of user's speech, the user could not confirm how the robot recognized the contents of conversation and the user had the sense of anxiety during the conversation.

### SUMMARY OF THE INVENTION

In view of the foregoing, an object of this invention is to provide a dialogue control system, a dialogue control method and a robotic device capable of remarkably improving the entertainment factor.

According to the present invention described above, in the dialogue control system in which the robot and the information processing device are connected via the network, since in the case of interacting by playing word games between the robot and the user, the history data concerning the word game in the user's speech contents is formed and transmitted to the information processing device and said information processing device selectively reads out the content data best suited to the user from the memory means based on said history data and provides to the original robot, the conversation between the user and the robot can have amusingness and rhythm, and can be brought closer to natural daily conversation as if the fellow men are talking. Thereby, the dialogue control system capable of remarkably improving the entertainment factor can be realized.

According to the present invention, in the dialogue control method in which the robot and the information processing device are connected via the network, since in the case of interacting by playing on words between the robot and the user, the history data concerning the word game in the user's speech contents is formed and transmitted to the information processing device, and said information processing device selectively reads out the content data best suited to the user from multiple content data based on the history data and provides to the original robot, the conversation between the user and the robot can have amusingness and rhythm and can be brought closer to natural daily conversation as if the fellow men are talking. Thereby, the dialogue control method capable of remarkably improving the entertainment factor can be realized.

Moreover, according to the present invention, in the robotic device to which the information processing device is connected via the network, since the interactive means having the function to interact with the man and for recognizing the user's speech through the conversation, the forming means for forming the history data on the word game from the user's speech contents by the interactive means, the updating means for updating the history data formed by the forming means based on user's speech contents obtained through the word game and the communication means for transmitting the history data to the information processing device via the network when starting the word game are provided; and when content data selected based on the history data transmitted from the communication means is transmitted via the network out of content data showing the contents of multiple word games memorized in advance in the information processing device, the interactive means outputs contents of the word game based on said content data, the conversation between the user and the robot can have amusingness and rhythm and can be brought closer to natural daily conversation as if the fellow men are talking. Thereby the robotic device capable of remarkably improving the entertainment factor can be realized.

The nature, principle and utility of the invention will become more apparent from the following detailed description when read in conjunction with the accompanying drawings in which like parts are designated by like reference numerals or characters.

### BRIEF DESCRIPTION OF DRAWINGS

In the accompanying drawings:

FIG. 1 is a perspective view showing the external construction of a robot according to the present invention;

FIG. 2 is a perspective view showing the external construction of a robot according to the present invention;

FIG. 3 is a perspective view showing the external construction of a robot according to the present invention;

FIG. 4 is a block diagram showing the internal construction of a robot;

FIG. 5 is a block diagram showing the internal construction of a robot;

FIG. 6 is a brief linear diagram showing the construction of the dialogue control system according to the present invention;

FIG. 7 is a block diagram showing the construction of a content server shown in FIG. 6;

FIG. 8 is a block diagram showing the processing of main control unit 40;

FIG. 9 is a conceptual diagram showing the relationship between SID and name in the memory;

FIG. 10 is a flow chart showing the name study processing procedure;

FIG. 11 is a flow chart showing the name study processing procedure;

FIG. 12 is a diagram showing dialogue examples at the time of name study processing;

FIG. 13 is a diagram showing dialogue examples at the time of name study processing;

FIG. 14 is a conceptual diagram showing the new registration of SID and name;

FIG. 15 is a diagram showing dialogue examples at the time of name study;

FIG. 16 is a diagram showing dialogue examples at the time of name study;

FIG. 17 is a block diagram showing the construction of audio recognition unit;

FIG. 18 is a conceptual diagram illustrating the word dictionary;

FIG. 19 is a conceptual diagram illustrating the grammatical rule;

FIG. 20 is a conceptual diagram illustrating the memory contents of feature vector buffer;

FIG. 21 is a conceptual diagram illustrating the score sheet;

FIG. 22 is a flow chart showing the audio recognition processing procedure;

FIG. 23 is a flow chart showing the unregistered word processing procedure;

FIG. 24 is a flow chart showing the cluster division processing procedure;

FIG. 25 is a conceptual diagram showing the simulation result;

FIG. 26 is a flow chart showing the content data acquisition processing procedure and the content data offering processing procedure;

FIG. 27 is a conceptual diagram illustrating the profile data;

FIG. 28 is a conceptual diagram illustrating the content data;

FIG. 29 is a conceptual diagram illustrating the dialogue sequence according to the word game;

FIG. 30 is a flow chart showing the popularity index summing processing procedure and the option data updating processing procedure;

FIG. 31 is a flow chart showing the content collection processing procedure and the content data add-up registration processing procedure; and

FIG. 32 is a conceptual diagram illustrating the dialogue sequence according to the word game.

### DETAILED DESCRIPTION OF THE EMBODIMENT

Preferred embodiments of this invention will be described in detail with reference to the accompanying drawings:

(1) Construction of Robot According to the Present Invention

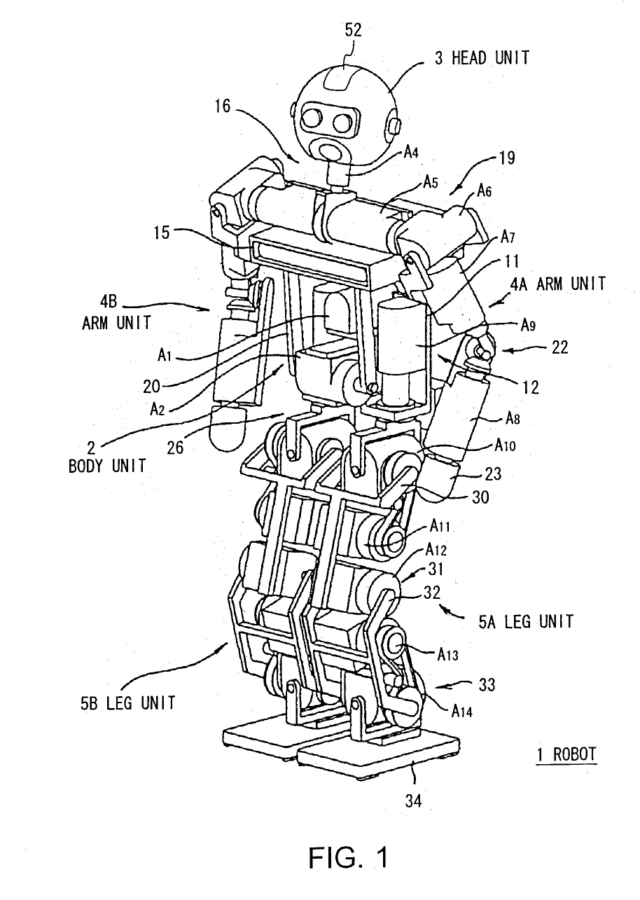

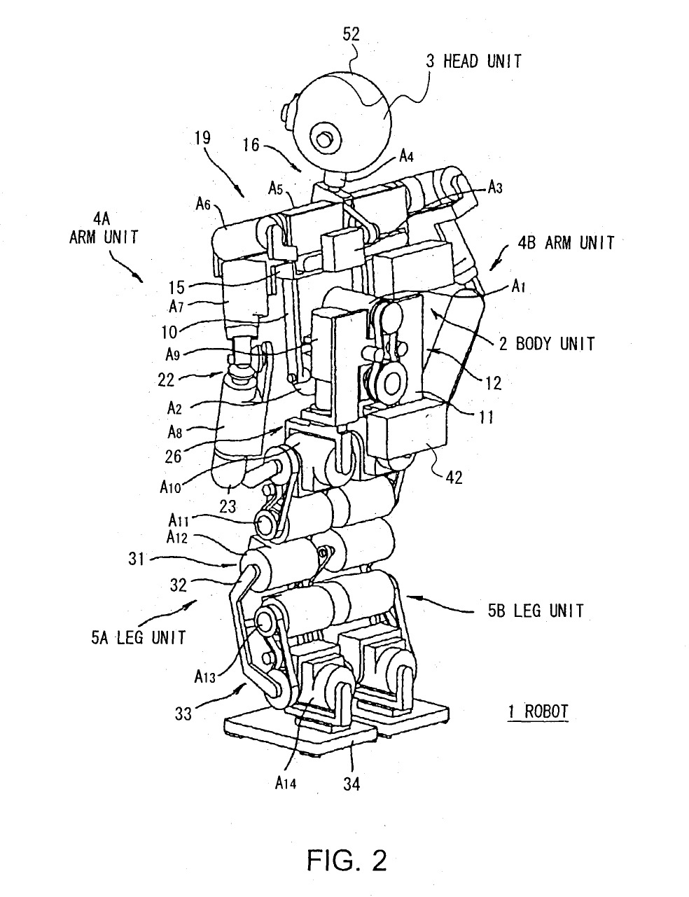

In FIGS. 1 and 2, Reference numeral 1 generally shows a two-foot walking type robot according to the present invention. This robot comprises a head unit 3 which is provided on the upper part of a body unit 2, and arm units 4A, 4B having the same construction which are placed on the left and right of the upper part of said body unit 2 respectively, and leg units 5A, 5B having the same construction which are attached respectively to the predetermined positions on the right and left of the lower part of the body unit 2.

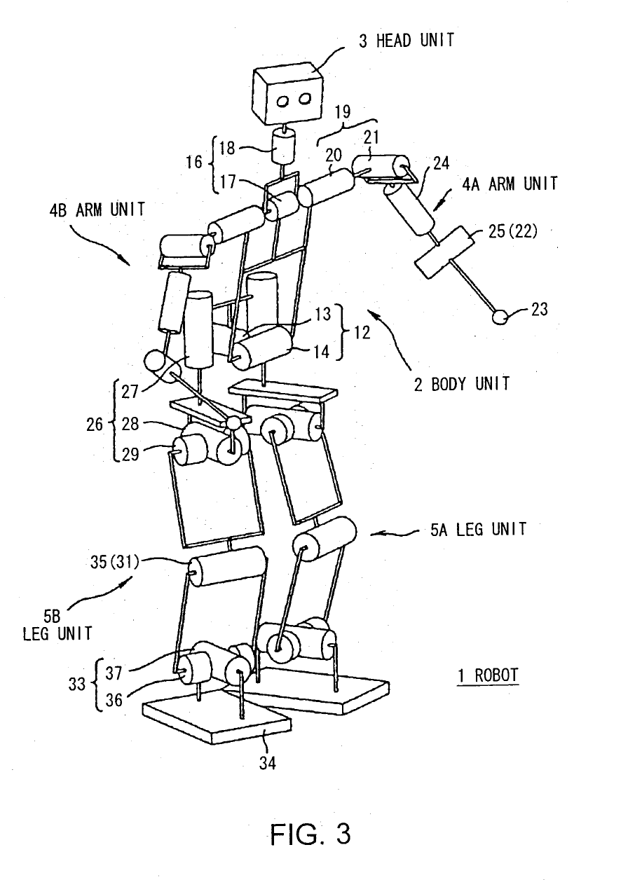

The body unit 2 is comprised of a frame 10 forming the upper part of the main body and a waste base 11 connected via the waste joint system 12, by driving each actuator 1A, A2 of the waste joint system 12 fixed to the waste base 11 of the lower part of the body, the upper part of the body can be rotated about the roll axis 13 and the pitch axis 14 independently shown in FIG. 3, which are orthogonal to each other.

Furthermore, the head unit 3 is attached to the upper surface central part of the shoulder base 15 fixed to the upper edge of the frame 10 via the head joint system 16, and by driving each actuator A3, A4 of the neck joint system 16 respectively, the head unit 3 can be rotated about the pitch axis 17 and the yawing axis 18, which are orthogonal to each other, shown in FIG. 3.

Furthermore, arm units 4A, 4B are attached to the right and left of the shoulder base 15 via the shoulder joint system 19 respectively, and by driving the actuators A5, A6 of the corresponding shoulder joint system 19 respectively, the arm units 4A, 4B can be rotated about the pitch axis 20 and the roll axis 21, which are orthogonal to each other, shown in FIG. 3, respectively.

In this case, each of arm units 4A and 4B is comprised of an actuator A8 forming the front arm part connected to the output axis of the actuator A7 forming its upper arm part via the elbow joint system 22 and a hand unit 23 is attached to the edge of said front arm part.

Then, in the arm units 4A and 4B, the front arm part can be turned about the yawing axis 24 shown in FIG. 3 by driving the actuator A7, and the front arm part can be turned about the pitch axis 25 shown in FIG. 3 by driving the actuator A8.

On the other hand, leg units 5A and 5B are attached to the waste base 11 of the lower body part via the coxa system 26 respectively, and by driving the corresponding actuator A9-A11 of the coxa system 26, these can be rotated about the yawing axis 27, roll axis 28 and the pitch axis 29, which are orthogonal each other, shown in FIG. 3 independently.

In this case, in leg units 5A, 5B, frame 32 forming the lower thigh part is connected to the lower edge of the frame 30 forming the thigh part via the knee joint system 31, and the leg part 34 is connected to the lower edge of the frame 32 via the ankle joint system 33.

Thus, in the leg units 5A and 5B, by driving the actuator A12 forming the knee joint system 31, its lower thigh part can be rotated about the pitch axis 35, and by driving actuators A13, A14 of the ankle joint system 33 respectively, the leg part 34 can be rotated about the pitch axis 36 and the roll axis 37 orthogonal to each other, shown in FIG. 3 independently.

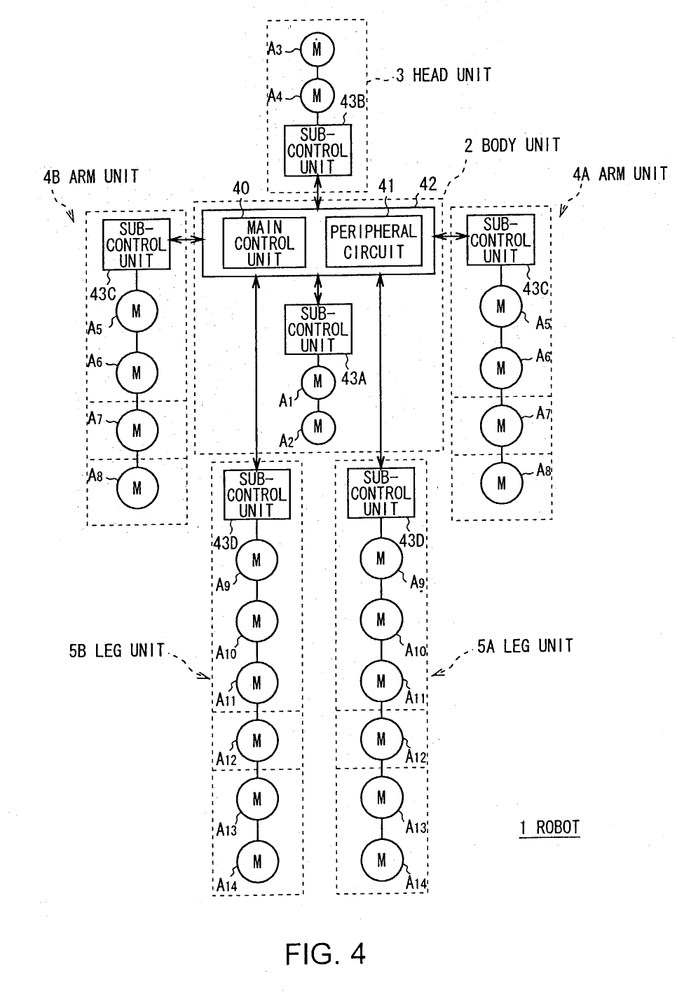

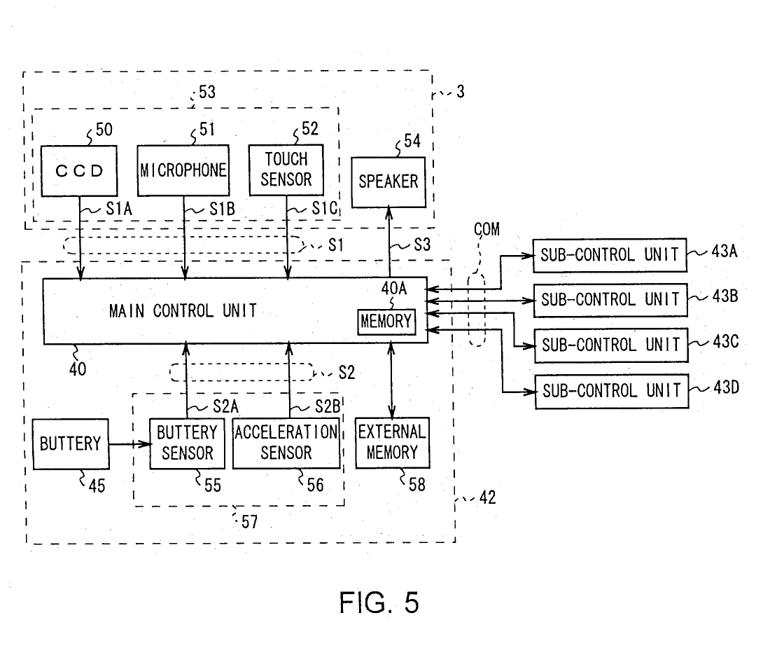

On the other hand, on the back side of the waste base 11 forming the body stem lower part of the body unit 2, a main control unit 40 for controlling the whole operation of the robot 1, as shown in FIG. 4, a control unit 42 in which the peripheral circuit 41 such as the power source circuit and the communication circuit, and a battery 45 (FIG. 5) are stored in the box is provided.

Then, this control unit 42 is connected respectively to each of sub-control units 43A-43D provided in each of construction units (body unit 2, head unit 3, arm units 4A, 4B and leg units 5A, 5B), and it supplies the required power source voltage to these sub-control units 43A-43D and can communicate with these sub-control units 43A-43D.

Furthermore, these sub-control units 43A-43D are connected respectively to corresponding actuators A1-A14 in construction units, and can drive actuators A1-A14 in said construction unit in the state specified based on various control commands to be given from the main control unit 40.

Furthermore, as shown in FIG. 5, in the head unit 3 a (charge coupled device) CCD camera 50 to function as “eyes” of the robot 1, a microphone 51 to function as “ears” of the robot 1, and an external sensor 53 formed of such as touch sensor 52, and a speaker 54 to function as “mouth” are placed respectively on the predetermined positions. And the internal sensor 57 formed of such as the buttery sensor 55 and the acceleration sensor 56 are provided in the control unit 42.

Then, the CCD camera 50 of the external sensor 53 takes pictures of the surrounding conditions, and outputs the resultant image signal S1A to the main control unit. While, the microphone 51 collects various command sounds such as “walk”, “lie down” or “chase after a ball” to be given from the user as the speech input, and transmits the resultant audio signal S1B to the main control unit 40.

Moreover, as is clear from FIGS. 1 and 2, the touch sensor 52 is provided on the upper part of the head unit 3 and detects the pressure received by the physical influence such as “hit” and “pat” from the user and outputs the detection result to the main control unit 40 as the pressure detection signal S1C.

Furthermore, the battery sensor 55 of the internal sensor unit 57 detects the remaining quantity of energy in the battery 45 at the predetermined cycle and transmits the detection result to the main control unit 40 as the battery remaining quantity detection signal S2A. On the other hand, the acceleration sensor 56 detects the acceleration of 3-axis direction (x-axis, y-axis and z-axis) at the predetermined cycle and transmits the detection result to the main control unit 40 as the acceleration detection signal S2B.

The main control unit 40 judges the surrounding condition and the internal condition of the robot 1, and the existence or non-existence of the command from the user and the influence of the user based the image signal S1A, audio signal S1B and the pressure detection signal S1C to be supplied respectively from the CCD camera 50, microphone 51 and touch sensor 52 of the external sensor unit 53 (hereinafter referred to as external sensor signal S1) and the battery remaining quantity detection signal S2A and the acceleration detection signal S2B to be supplied from the battery sensor 55 and the acceleration sensor of the internal sensor unit 57 (hereinafter referred to as an internal sensor signal S2).

Then, the main control unit 40 determines the action to be followed based on said judgment result and the control program stored in advance in the internal memory 40A and various control parameters stored in the external memory 58 equipped at that time, and outputs the control command based on the determination result to the corresponding sub-control units 43A-43D. As a result, based on this control command, the corresponding actuators A1-A14 will be driven under the control of the sub-control units 43A -43D and thus, actions such as making the head unit 3 swing up and down, right and left and the arm units 4A, 4B put up, and to walk, can be realized by the robot 1.

Furthermore, in this case the main control unit 40, giving the predetermined audio signal S3 to the speaker 54 as necessary, outputs speeches based on said audio signal S3, and by outputting the driving signal to the LED provided on the predetermined part of the head unit 3 functioning as “eyes” by appearances, flushes this head unit 3.

With this arrangement, this robot 1 can act autonomously based on the surrounding and internal conditions and the existence or non-existence of the command and actions from the user.

(2) Construction of Dialogue Control System according to the Present Invention

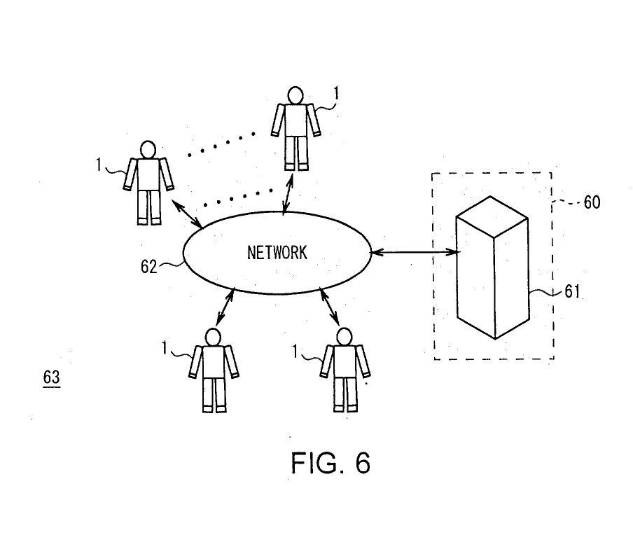

FIG. 6 shows the dialogue control system 63 in which the plural number of robots 1 owned by the user and the content server 61 provided by the information provider side 60 are connected via the network 62, according to the present embodiment.

Each robot 1 autonomously acts according to the command from the user and the surrounding environment, and by communicating with the content server 61 via the network 62, it can receive and transmit the necessary data and can output sounds based on the content data obtained by said communication via the speaker 54 (FIG. 5).

In practice, in each robot 1, an application software such as recorded on the (Compact Disc) CD-ROM and to be offered, for performing the function as the whole dialogue control system 63, will be installed, and the wireless LAN card (not shown in Fig.) compliant with the predetermined wireless communication standards such as Bluetooth is to be installed onto the predetermined part in the body unit 2 (FIG. 1).

Furthermore, the content server 61 is the Web server and the database server to conduct various kinds of processing on various services to be provided by the information provider side 60, and it can communicate with the robot 1 accessed through the network 62 and can receive and transmit the necessary data.

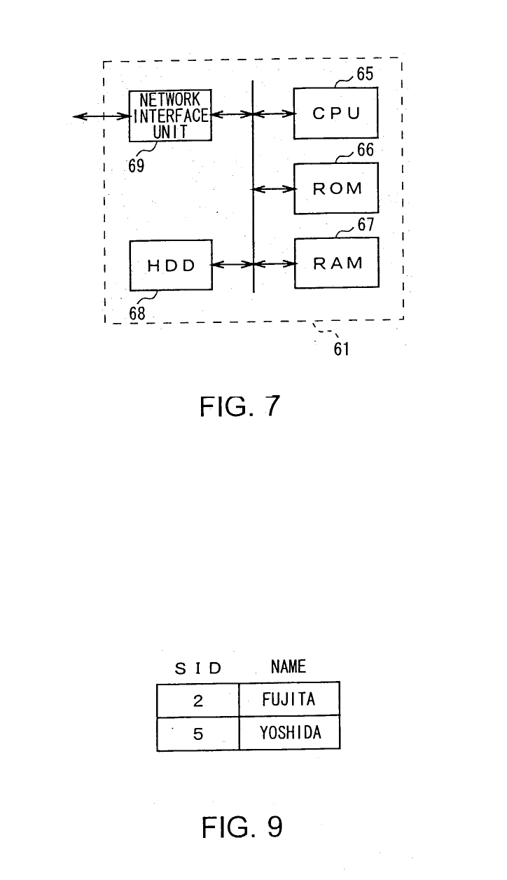

FIG. 7 shows the construction of content server 61. As is clear from this FIG. 7, the content server 61 is comprised of CPU 65 for controlling the overall control of the content server 61, ROM 66 in which various kinds of softwares are stored, RAM 67 as the work memory of CPU 65, hard disk device 68 in which various data are stored, network interface unit 69 that is the interface for CPU 65 communicate with-the external world via the network 62 (FIG. 6), and these are connected each other via the bus 70.

In this case, CPU 65 captures the data and command to be given from the robot 1 which made access through the network 62 via the network interface unit 69, and executes various processing based on said data and command and the software stored in the ROM 66. This network interface unit 69 comprises LAN control unit (not shown in Fig.) for exchanging various data using the wireless LAN system such as Bluetooth.

Then, as a result of said processing, CPU 65 transmits the screen data of the predetermined Web page read out from the hard disk device 68 and the other program or the command data to the corresponding robot 1 via the network interface unit 69.

Thus, the content server 61 can receive and transmit the screen data of Web pages and other necessary data to the robot 1 which made access to this server.

In the hard disk device 68 of the content server 61, multiple database (not shown in Fig.) are stored, and thus, the user can read out the necessary information from the corresponding database when conducting various processing.

A vast amount of content data required for the word game such as a riddle is stored in one of the database. And option data showing various contents to be obtained with said word game is added to said content data in addition to the data showing the actual content to be used in the word game.

More specifically, when the “riddle, What is this?” is designated as the word game, the content data shows the question, the answer and the reason of that “riddle”, and the option data added to said content data shows the degree of difficulty of that question and the index of popularity to be obtained from the number of times that question has been used.

Then, the robot 1 recognizes the contents of the user's conversation collected via the microphone 51 by executing the speech recognition processing to be described later, and transmits said recognition result to the content server 61 with various data related to the user via the network 62.

Then next, based on the recognition result obtained from the robot 1, the content server 61 extracts the content data best suited from a large amount of content data stored in the database, and transmits said content data to the original robot 1.

Thus, by dispatching the sound based on the content data obtained from the content server 61 via the speaker 54, the robot 1 can play the word game such as “riddle”, with the user naturally as if the fellow men are talking each other.

(3) Processing of Main Control Unit 40 Re: Name Study Function

Then, the name study function loaded on this robot 1 will be explained. This robot 1 is equipped with the name study function for acquiring the person's name through the conversation with that person, and as well as memorizing that name associated with the data of acoustic feature of that person's voice detected based on the output of the microphone 51, recognizing the appearance of new person whose name has not been obtained, and by memorizing that new person's name and the acoustic feature of his voice in the same manner as in the above case, studying the person's name associated with that person (hereinafter referred to as the name study). The person whose name has been memorized associated with the acoustic feature of that person's voice will be referred to as a “known person”, and the person whose name has not been memorized will be referred to as a “new person” hereunder.

Then, this name study function will be realized by various processing in the main control unit 40.

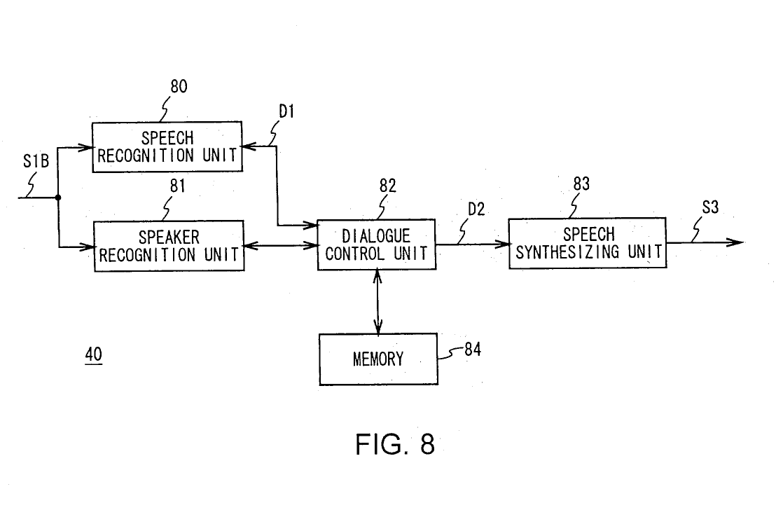

At this point, the processing content of the main control unit 40 relating to such name study function can be classified as follows: as shown in FIG. 8, the speech recognition unit 80 for recognizing words voiced by the man, the speaker recognition unit 81 for detecting the acoustic feature of the person's voice, and recognizing that person based on said detected acoustic feature; the dialogue control unit 82 for controlling various controls for studying new person's name including the interactive control with the man and the memory control of the known person's name and the acoustic feature; and the audio synthesis unit 83 for forming the audio signal S3 for various kings of conversations under the control of dialogue control unit 82 and transmitting to the speaker 54 (FIG. 5).

In this case, the speech recognition unit 80 has the, function to recognize words contained in the audio signal S1B per word by executing the predetermined speech recognition processing based on the audio signal S1B from the microphone 51 (FIG. 5), and transmits these words recognized to the dialogue control unit 82 as the character sequence data D1.

Furthermore, the speaker recognition unit 81 has the function to detect the acoustic feature of the person's voice contained in the audio signal S1B to be given from the microphone 51 according to the predetermined signal processing in utilizing the method such as described in “Segregation of Speakers for Recognition and Speaker Identification (CH2977-7/91/000-0873 S1.00 1991 IEEE)”.

Furthermore, under the normal conditions the speaker recognition unit 81 successively compares the data of acoustic feature detected at this time with the data of acoustic feature of all known persons memorized at that time. And in the case where the acoustic feature detected at that time agrees with the acoustic feature of any known person, it informs the specific identification of said acoustic properties (hereinafter referred to as SID) associated with the acoustic feature of the known person. On the other hand, in the case where the acoustic feature detected does not agree with the acoustic feature of any known person, it informs SID (=−1), meaning identification impossible to the dialogue control unit 82.

Furthermore, when the dialogue control unit 82 judges that the speaker is a new person, the speaker recognition unit 81 detects the acoustic feature of that person's voice based on the start command of new study and the study stop command to be given from the dialogue control unit 82, and as well as memorizing said data of acoustic feature detected associated with new specific SID, informs this SID to the dialogue control unit 82.

The speaker recognition unit 81 can conduct the additional study to collect the data of acoustic feature of that person's voice in response to the start command and the stop command of the additional study from the dialogue control unit 82.

The audio synthesizing unit 83 has the function to convert the character sequence data D2 to be given from the dialogue control unit 82 to the audio signal S3, and it outputs the resulting audio signal S3 to the speaker 54 (FIG. 5). With this arrangement, the sound/voice based on this audio signal S3 can be put out from the speaker 54.

As shown in FIG. 9, the dialogue control unit 82 is equipped with a memory 84 (FIG. 8) for memorizing the known person's name and the SID associated with the acoustic feature data of that person's voice memorized by the speaker recognition unit 81.

Then, the dialogue control unit 82, by giving the predetermined character sequence data D2 to the audio synthesizing unit 83 at the predetermined timing, outputs the speech for asking the name to the speaking partner or confirming his name from the speaker 54, and at this moment, the dialogue control unit 82 judges whether that person is new or not based on the recognition results of the speech recognition unit 80 and the speaker recognition unit 81 based on that person's response at that time and the combined information of said known person's name and SID stored in the memory 84.

Then, when the dialogue control unit 82 judges that the person is new, by giving the start command of the new study and the stop command to the speaker recognition unit 81, makes the speaker recognition unit 81 collect and memorize the acoustic feature data of that new person's voice; and the dialogue control unit 82 stores the SID associated with the acoustic feature data of that new person to be given from the speaker recognition unit 81 as a result in the memory 84 associated with that person's name obtained by such conversation.

Furthermore, when the dialogue control unit 82 judges that the person is known person, as well as making the speaker recognition unit 81 conduct the additional study by giving the start command of additional study, sequentially outputs the predetermined character sequence data D2 to the audio synthesizing unit 83, and makes the speaker recognition unit 81 conduct the interactive control so that the speaker recognition unit 81 can keep the conversation with that person till it can collect the considerable volume of data required for the additional study.

(4) Concrete Processing of Dialogue Control Unit 82 Re Name Study Function

Next, the processing contents of the dialogue control unit 82 regarding the name study function will be described in detail in the following paragraphs.

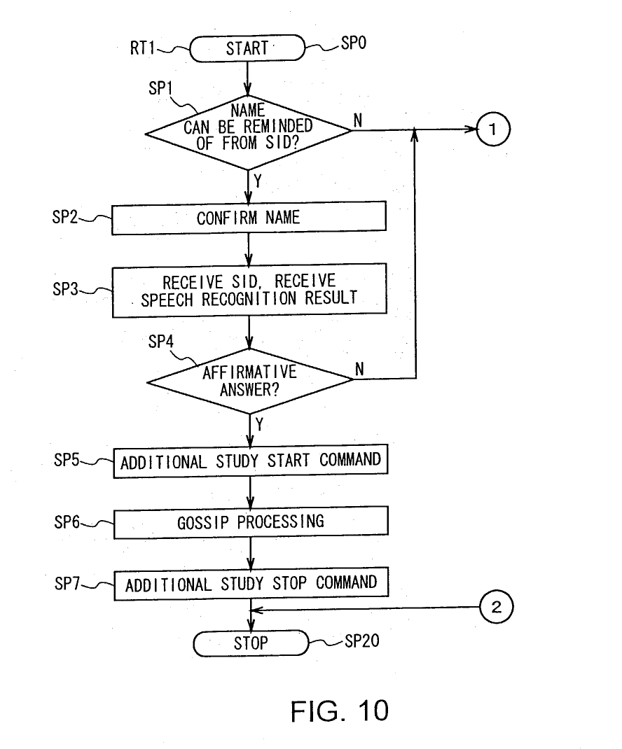

The dialogue control unit 82 executes various processing for sequentially studying new person's name according to the name study processing procedure RT1 shown in FIGS. 10 and 11 based on the control program stored in the external memory 58 (FIG. 5).

More specifically, when the SID is given from the speaker recognition unit 81 after recognizing the voice characteristics of the person's voice based on the audio signal S1B from the microphone 51, the dialogue control unit 82 starts the name study processing procedure RT1 at the step SP0. And at the following step SP1, it judges whether the corresponding name can be detected or not (i.e., whether the SID is “−1” meaning recognition impossible, or not) from the SID based on the information in which the known person's name stored in the memory 84 and the corresponding SID are associated (hereinafter referred to as associated information).

At this point, the case of obtaining an affirmative result at the step SP1 means that the speaker recognition unit 81 memorizes the data of acoustically characteristic of that person's voice, and the SID associated with that data means the known person stored in the memory 84 associated with that person's name. However, even in this case, it is considered that the speaker recognition unit 81 misconceives the new person as the known person.

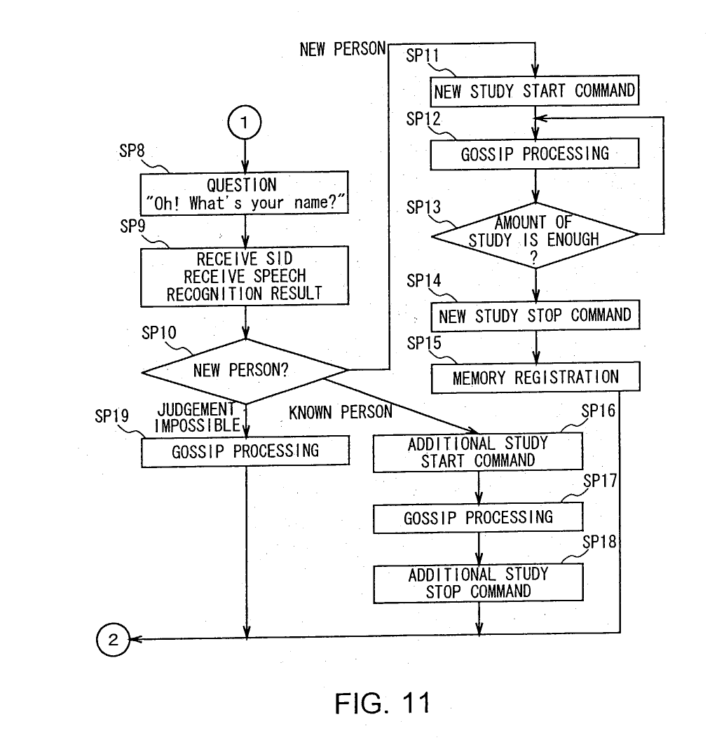

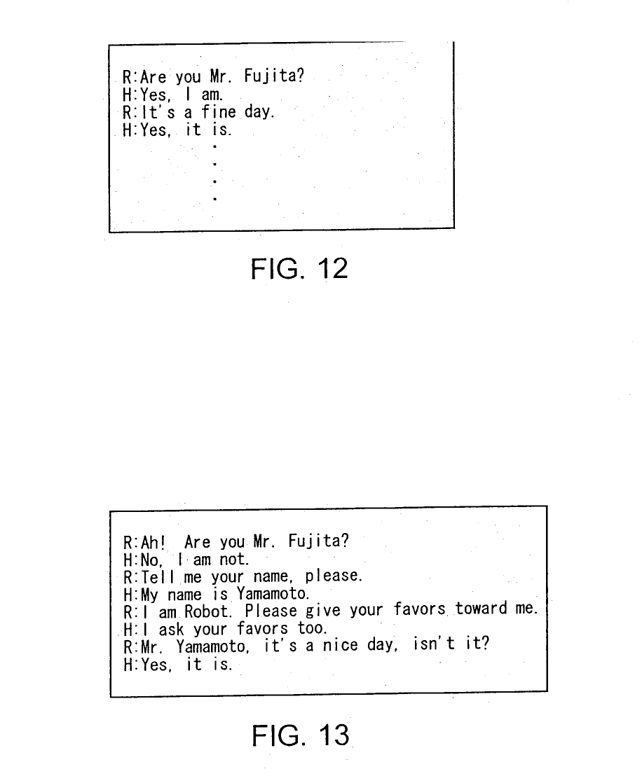

Thus, in the case where the dialogue control unit 82 obtains an affirmative result at the step SP1, it proceeds to the step SP2 and by outputting the predetermined character sequence data D2 to the audio synthesizing unit 83, outputs the sound of question from the speaker 54 confirming whether or not the name of that person such as shown in FIG. 12 “Are you Mr. A?” agrees with the name detected from the SID (Mr. A).

Next, the dialogue control unit 82 proceeds to the step SP3 and waits for the response of audio recognition result from the speech recognition unit 80, an answer to that question such as “Yes, I am”, or “No, I am not”. Then, if the audio recognition result is given from the speech recognition unit 80, and the SID that is the speaker recognition result at that time is given from the speaker recognition unit 81, the dialogue control unit 82 proceeds to the step SP4 and judges whether that person's answer is affirmative one or not based on the speech recognition result from the speech recognition unit 80.

Obtaining an affirmative result at this step SP4 means that the name detected based on the SID provided from the speaker recognition unit 81 at the step SP1 agrees with that person's name and that person can be judged almost as the person in question having the name detected by the dialogue control unit 82.

Thus, at this point, the dialogue control unit 82 determines that said person is the person in question having the name detected by said dialogue control unit 82 and proceeding to the step SP5, gives a command to start the additional study to the speaker recognition unit 81.

Then, the dialogue control unit 82 proceeds to the step SP6 and successively transmits the character sequence data D2 for prolonging the conversation with that person to the audio synthesizing unit 83. Then, when the fixed time enough for the additional study would be elapsed, the dialogue control unit 82 proceeds to the step SP7, and after giving a command to stop the additional study to the speaker recognition unit 81, proceeds to the step SP20 and stops the name study processing to that person.

On the other hand, if a negative result is obtained at the step SP1, this means that the person whose voice is recognized by the speaker recognition unit 81 is a new person, or the speaker recognition unit 81 has mistaken the known person for the new person. Moreover, if the negative result is obtained at the step SP4, this means that the name detected from the SID given from the speaker recognition unit 81 at first does not agree with that person's name. And in either case, it can be said that the dialogue control unit 82 does not grasp that person correctly.

Then, when the dialogue control unit 82 obtains a negative. result at the step SP1, or it obtains a negative result at the step SP4, it proceeds to the step SP8, and giving the character sequence data D2 to the audio synthesizing unit 83, it outputs the speech of question for getting that person's name such as “Tell me your name please” from the speaker 54.

Then, the dialogue control unit 82 proceeds to the step SP9 and waits for the answer of audio recognition result (i.e., name) such as an answer to that question, “I am A”, and the speaker recognition result (i.e., SID) of the speaker recognition unit 81 at said answer time would be given from the speech recognition unit 80 and the speaker recognition unit 81.

Then, when the speech recognition result is given from the speech recognition unit 80 and the SID is given from the speaker recognition unit 81, the dialogue control unit 82 proceeds to the step SP10 and judges whether that person is a new person or not based on these speech recognition result and the SID.

In the case of this embodiment, such judgement will be conducted according to the majority of 2 recognition results formed of the name obtained by the speech recognition of the speech recognition unit 80 and the SID from the speaker recognition unit 81, and if a negative result is obtained in either one of them, it will be suspended.

For example, in the case where the SID from the speaker recognition unit 81 is “−1” meaning that recognition impossible, and the person's name obtained based on the speech recognition result from the speech recognition unit 80 at the step SP9 has no connection with any SID in the memory 84, that person is judged as a new person. Because this is the condition in which the person having no resemblance in his face or voice to the known person's face or voice has a completely new name, such judgment can be made.

Furthermore, even in the case where the SID from the speaker recognition unit 81 is associated with the different name in the memory 84 and that person's name obtained based on the speech recognition result from the speech recognition unit 80 is not stored in the memory 84 at the step SP9, the dialogue control unit 82 judges that said person is a new person. The reason is that the new category is liable to be mistaken for the known category in various kinds of processing. Moreover, considering the name of a person whose voice is recognized is not registered, it can be judged as a new person with considerable assurance.

On the other hand, in the case where the SID from the speaker recognition unit 81 is associated with the same name in the memory 84, and the person's name obtained based on the voice recognition result from the speech recognition unit 80 at the step SP9 is the name with which the SID is associated, the dialogue control unit 82 judges that said person is the known person.

Furthermore, in the case where the SID from the speaker recognition unit 81 is associated with the different name in the memory 84, and the person's name obtained based on the speech recognition result from the speech recognition unit 80 at the step SP9 is the name with which the SID is associated, the dialogue control unit 82 does not judge whether said person is the known person or new person. In this case, it is considered that either recognition of the speech recognition unit 80 and the speaker recognition unit 81 or both of them may be wrong, it cannot be determined at this stage. Accordingly, in this case such judgement will be left open.

Then, in the case where the dialogue control unit 82 judges that such person is the new person according to said judgment processing at the step SP10, proceeding to the step SP11, gives a start command of new study to the speaker recognition unit 81. And then, it proceeds to the step SP12, and transmits the character sequence data D2 for prolonging the conversation with that person to the audio synthesizing unit 83.

Furthermore, the dialogue control unit 82 proceeds to the step SP13 and judges whether the collection of acoustic feature data in the speaker recognition unit 81 has reached to the sufficient amount or not. And if a negative result is obtained, returning to the step SP12, it repeats the loop of steps SP12-SP13-SP12 till it gets an affirmative result.

Then, when an affirmative result is obtained at the step SP13 after the collection of acoustic feature data in the speaker recognition unit 81 reaches to the sufficient amount, the dialogue control unit 82 proceeds to the step SP14 and gives a stop command of new study to the speaker recognition unit 81. As a result, that acoustic feature data is associated with the new SID and memorized in the speaker recognition unit 81.

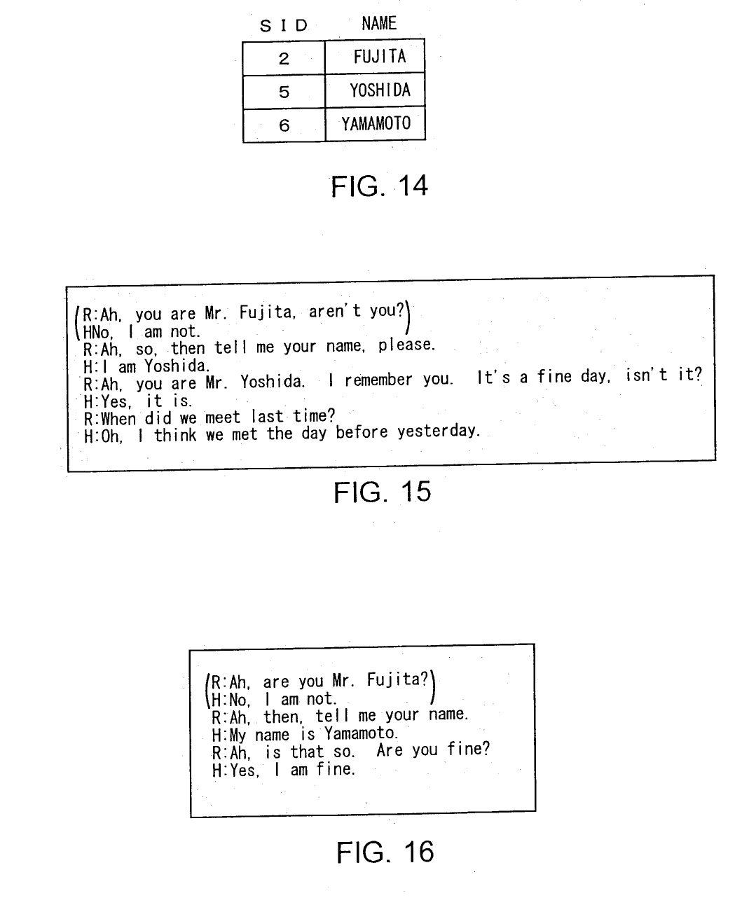

Furthermore, the dialogue control unit 82 proceeds to the following step SP15 and waits for such SID to be given from the speaker recognition unit 81. Then, when it is given, such as shown in FIG. 14, it registers this in connection with that person's name obtained based on the speech recognition result from the speech recognition unit 80 at the step SP9. Then, the dialogue control unit 82 proceeds to the step SP20 and terminates the name study processing for that person.

On the other hand, in the case where the dialogue control unit 82 judges that such person is the known person at the step SP10, it proceeds to the step SP16. If the speaker recognition unit 81 correctly recognizes that known person (i.e., in the case where the speaker recognition unit 81 output the same SID as the SID associated with that known person stored in the memory 84 as the connected information based on the recognition result), it gives a start command of additional study to that speaker recognition unit 81.

More specifically, in the case where the SID from the speaker recognition unit 81 obtained at the step SP9 and the SID given from the speaker recognition unit 81 at first are connected with the same name in the memory 84, and the name obtained based on the speech recognition result from the speech recognition unit 80 at the step SP9 is the name connected with that SID, that person is determined as the known person at the step SP10 and the dialogue control unit 82 gives a command to start the additional study to the speaker recognition unit 81.

Then, the dialogue control unit 82 proceeds to the step SP17, and successively outputs the character sequence data D2 for extending the conversation with that person, such as “Oh, you are Mr. A, aren't you? I remember you.” “It is a nice day, isn't it?.”, “When did I meet you last?”. And when the fixed time enough for the additional study has elapsed, it proceeds to the step SP18, and after giving a stop command of additional study to the speaker recognition unit 81, it proceeds to the step SP20 and terminates the name study processing to that person.

Furthermore, in the case where the SID from the speaker recognition unit 81 obtained at the step SP9 and the SID given from the speaker recognition unit 81 at first are connected with the different name in the memory84, and the name obtained based on the speech recognition result from the speech recognition unit 80 at the step SP9 is the name connected with such SID, that person cannot be determined as the known person or the new person, the speaker recognition unit 81 proceeds to the step SP19, and successively outputs the character sequence data D2 for making a chat such as “Oh, is that so? Are you fine?” as show in FIG. 16 to the audio synthesizing unit 83.

In this case, the dialogue control unit 82 does not give the start command and the stop command of new study or additional study (i.e., it does not make the speaker recognition unit 81 conduct either the new study or the additional study), and when the fixed time has elapsed, it proceeds to the step SP20 and terminates the name study processing to that person.

Thus, the dialogue control unit 82 can gradually study the name of a new person by conducting the interactive control with the person and the operation control of the speaker recognition unit 81 based on the recognition results of the speech recognition unit 80 and the speaker recognition unit 81.

The robot 1 obtains the person's name through the conversation with the new person and memorizes said name associated with the acoustic feature data of that person's voice detected based on the output of the microphone 51. And based on these various data memorized, the robot 1 recognizes the appearance of a new person whose name is not acquired, and it can learn and memorize the person's name by obtaining the name of that new person, the acoustic feature of his voice, and the configuration feature of his face in the same manner as in the case described above.

Accordingly, this robot 1 can learn names of the new person and objects naturally through the conversation with the normal person as if the human beings are conducting every day without needing the name registration by the clear specification from the user, such as the input of audio command and the push operation of touch sensor.

(5) Detailed Construction of Speech Recognition Unit 80

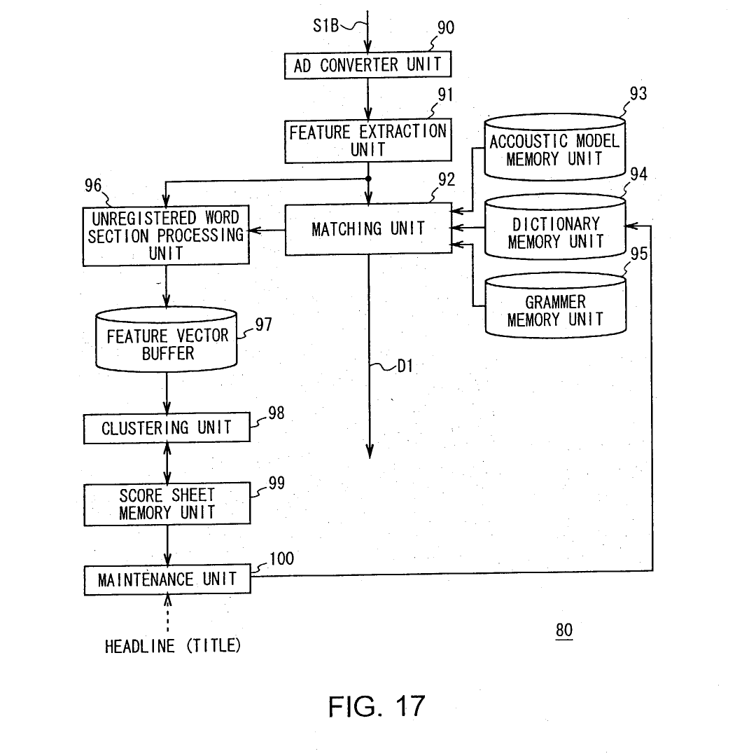

Next, in FIG. 17, the detailed construction of the speech recognition unit 80 for realizing the name study function described above will be explained.

In this speech recognition unit 80, an audio signal S1B from the microphone 51 is entered into the analog digital (AD) converter 90. The AD converter 90 will conduct the sampling and quantization onto the analog audio signal S1B supplied and will convert this to the digital signal audio data. This audio data will be supplied to the feature extraction unit 91.

The feature extraction unit 91 analyses the input audio data in each adequate frame, such as Mel Frequency Cepstrum Coefficient MFCC analysis, and outputs the resulting MFCC to the matching unit 92 and the unregistered word section processing unit 96 as the feature vector (feature parameter). Then, in the feature extraction unit 91, it is possible that such as the linear predictive coefficient, Cepstrum coefficient, line spectrum, power per the fixed frequency (output of filter bank) can be extracted as the feature vector.

The matching unit 92, referring to the acoustic model memory unit 93, the dictionary memory unit 94 and the grammar memory unit 95 in utilizing the feature vector from the feature extraction unit 91 as occasion demands, speech recognizes the voice (input speech) entered into the microphone 51 based on such as the Hidden Markov model (HMM) law.

More specifically, the acoustic model memory unit 93 memorizes acoustic model (e.g., including the standard pattern to be used in DP (Dynamic Programming) matching, other than HMM) showing the acoustic feature on the sub-words such as phoneme, syllable, and phoneme series in the audio language for identifying the speech. Here, since the speech recognition is conducted based on the Hidden Markov Model law, the HMM will be used as the acoustic model.

The dictionary memory unit 94 recognizes the word dictionary in which the information related to the pronunciation of the word clustered per unit (acoustic information) and the title of that word are connected.

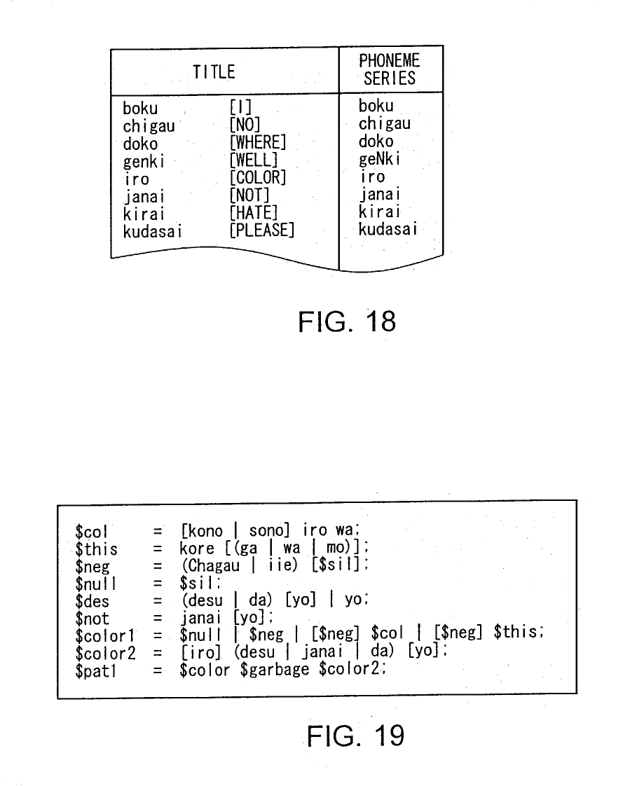

At this point, FIG. 18 shows a word dictionary memorized in the dictionary memory unit 94.

As shown in FIG. 18, in the word dictionary the title of word and its phoneme series are connected, and the phoneme series is clustered per the corresponding word. In the word dictionary of FIG. 18, one entry (1 line of FIG. 16) corresponds to one cluster.

In FIG. 18, the title is shown by the Romanized letter and the Japanese (kana-kanji) and the phoneme series is shown by the Romanized letter. Provided that “N” in the phoneme series shows the syllabic nasal sound “N”. Moreover; since one phoneme series is described in one entry in FIG. 18, it is possible to describe multiple phoneme series in one entry.

Returning to FIG. 17, the grammar memory unit 95 memorizes the grammatical rule in which how each word registered in the word dictionary of the dictionary memory unit 94 connects each other is described.

FIG. 19 shows the grammatical rule memorized in the grammar memory unit 95. The grammatical rule of FIG. 19 is described in the extended Backus Naur form (EBNF).

In FIG. 19, from the top of the line through the first appearing “;” shows one grammatical rule. Also the alphabet (column) to which “$” is attached to its top shows variable and the alphabet to which “$” is not attached shows the word title (the title by the Romanized letter shown in FIG. 18). Furthermore, the part surrounded by [ ] shows that this can be omitted, and “/” shows that either one of title words (or variables) placed in front and in rear will be selected.

Thus, in FIG. 19, the grammatical rule of the first line “$col=[Kono/sono] iro wa;” means that the variable $col is the word sequence of “kono iro (color) wa, or sono iro (color) wa”.

In the grammatical rule shown in FIG. 19, the variable $sil and $garbage are not defined. However, the variable $sil shows a silent acoustic model and the variable $garbage shows a garbage model which basically permitted the free transition among the phoneme series.

Again returning to FIG. 17, the matching unit 92 refers to the word dictionary of the dictionary memory unit 94, and by connecting the acoustic model memorized in the acoustic model memory unit 93, forms the acoustic model of word (word model). Also, the matching unit 92 connects several word models by referring the grammatical rule memorized in the grammar memory unit 95, and it recognizes the speech entered into the microphone by the HMM law based on the feature vector in utilizing the word model thus connected. More specifically, the matching unit 92 detects the word model series having the highest score (likelihood) that the feature vector of the time series to be put out from the feature extraction unit 91 can be observed, and outputs the title of word sequence corresponding to that word model series as a result of the speech recognition.

More specifically, the matching unit 92 identifies the speech entered into the microphone according to the HMM law based on the feature vector by using the word model connected by the word corresponding to the word model connected. The matching unit 92 detects the word model series having the highest score (likelihood) that the feature vector of the time series put out from the feature extraction unit 91 can be observed, and outputs the title of word series corresponding to that word model series as a speech recognition result.

To be more specific, the matching unit 92 accumulates the appearance probability (output probability) of each feature vector on the word series corresponding to the word model connected, and making that accumulated value as the score, outputs the title of word series to make that score the highest as a speech recognition result.

The speech recognition result entered into the microphone 51 as described above will be sent to the dialogue control unit 82 as the character series data D1.

In the embodiment of FIG. 19, there exists the grammatical rule (hereinafter referred to as the rule for unregistered word) using the variable $garbage showing a garbage model “$pat1=$color1 $garage $color2;” on the 9^{th} line from the top. However, if this rule for unregistered ward is applied, the matching unit 92 detects the speech section corresponding to the variable $garbage as the speech section of unregistered word. Furthermore, the matching unit 92 detects the phoneme series as the transition of phoneme series in the garbage model shown by the variable $garbage when the rule for unregistered word is applied. Then, the matching unit 92 supplies the speech section of unregistered word and the phoneme series to be detected when the speech recognition result to which the rule for unregistered word is applied is obtained, to the unregistered word section processing unit 96.

According to the rule for unregistered word “$pat1=$color1 $garbage $color”;“described above, one unregistered word existing between the phoneme series of words registered in the word dictionary shown by the variable #color1 and the phoneme series of words registered in the word dictionary shown by the variable $color2 will be detected. However, even in the case where the plural number of unregistered words are included in the speech, or the unregistered word is not listed between words registered in the word dictionary, the present embodiment can be applied.

The unregistered word section processing unit 96 temporarily memorizes the feature vector series to be supplied from the feature extraction unit 91. And when the unregistered word section processing unit 96 receives the unregistered word speech section and phoneme series from the matching unit 92, detects the speech feature vector series over that speech section from the feature vector series. Then, the unregistered word section processing unit 96 adds specific identification (ID) to the phoneme series (unregistered word) from the matching unit 92 and supplies the phoneme series of unregistered word with the feature vector series in that speech section to the feature vector buffer 97.

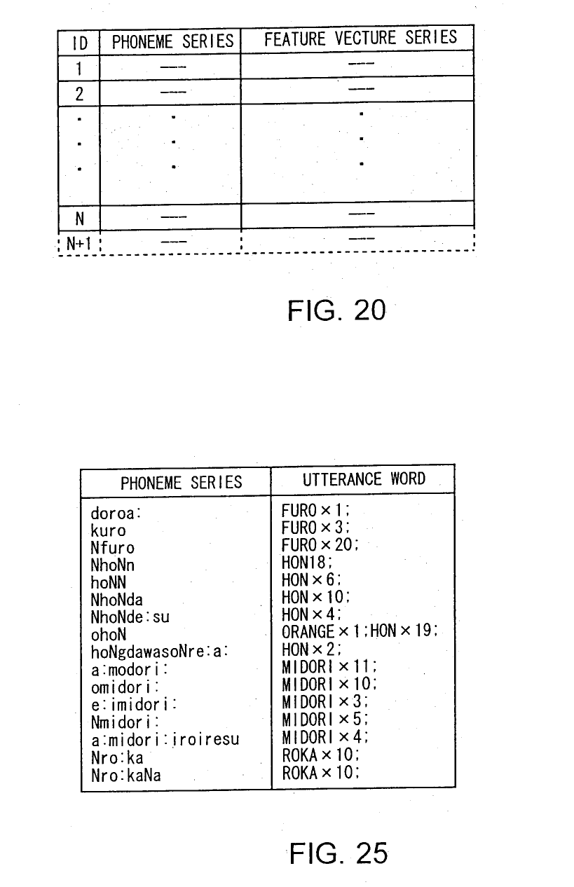

As shown in FIG. 20, the feature vector buffer 97 memorizes the ID of unregistered word to be supplied from the unregistered word section processing unit 96, the phoneme series and the feature vector series temporarily after making these connected.

In FIG. 20, sequential numbers from 1 are attached to the unregistered words as the ID. Thus, in the case where N numbers of IDs of unregistered words, the phoneme series and the feature vector series are memorized in the feature vector buffer 97, if the matching unit 92 detects the speech section and the phoneme series of the unregistered word, N+1 will be attached to that unregistered word as the ID in the unregistered word section processing unit 96, and in the feature vector buffer 97, the ID of that unregistered word, the phoneme series and the feature vector series will be memorized as shown in FIG. 20 by the dotted lines.

Again, returning to FIG. 17, the clustering unit 98 calculates the scores regarding the unregistered words newly memorized in the feature vector buffer 97 (hereinafter referred to as new unregistered word) and the other unregistered words already memorized in the feature vector buffer 97 (hereinafter referred to as memorized unregistered word).

More specifically, the clustering unit 98 calculates the score on the memorized unregistered word regarding the new unregistered word making the new unregistered words as the input speech and considering the memorized unregistered words as the words registered in the word dictionary as in the case of the matching unit 92. To be more precise, the clustering unit 98 recognizes the feature vector series of new unregistered word by referring the feature vector buffer 97, and simultaneously, it connects the acoustic model according to the phoneme series of the memorized unregistered word, and calculates the score as the likelihood that the feature vector series of new unregistered words are observed from that acoustic model connected.

The acoustic model memorized in the acoustic model memory unit 93 will be used.

Similarly, the clustering unit 98 calculates the score regarding the new unregistered word, and updates the score sheet memorized in the score sheet memory unit 99 based on that score.

Furthermore, the clustering unit 98, referring to the updated score sheet, detects the cluster to which new unregistered words will be added as the new member from the cluster in which unregistered words already obtained (memorized unregistered word) are clustered. Then, the clustering unit 98 divides that cluster based on the member of that cluster as the new member of the cluster in which new unregistered word is detected and updates the score sheet memorized in the score sheet memory unit 99 based on the division result.

The score sheet memory unit 99 memorizes the score sheets in which the score on the memorized unregistered word related to the new unregistered words and the score on the new unregistered word related to the memorized unregistered words are registered.

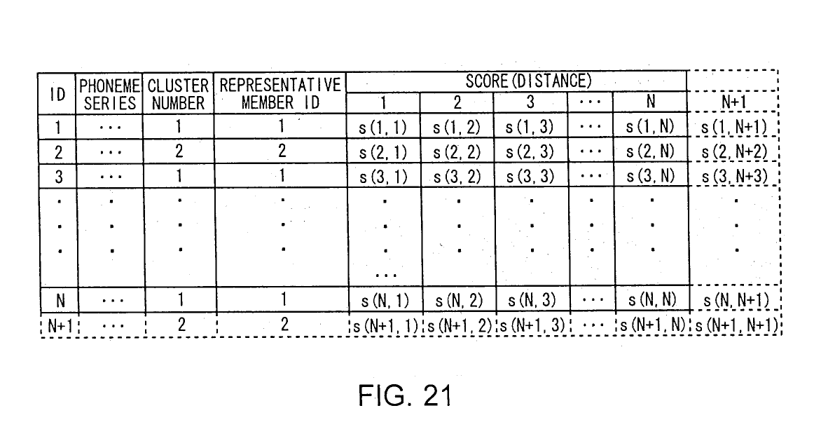

At this point, FIG. 21 shows the score sheet.

The score sheet is formed of the entry on which the unregistered word “ID”, “phoneme series”, “cluster number”, “representative member ID” and “score” are described.

As the unregistered word “ID” and “phoneme series”, the same ones memorized in the feature vector buffer 97 will be registered by the clustering unit 98. The “cluster number” is the number to specify the cluster in which the unregistered word of that entry becomes the member and that number is attached by the clustering unit 98 and registered. The “representative number ID” is the unregistered ID as the representative member representing the cluster in which the unregistered word of that entry becomes the member, and the representative member of the cluster in which the unregistered word is the member can be identified. The representative member of the cluster can be obtained by the clustering unit 98, and the ID of that representative member will be registered on the representative member ID of the score sheet. The “score sheet” is the score to each of other unregistered words on the unregistered words of that entry, and will be calculated by the clustering unit 98 as described above.

For example, if ID of N numbers of unregistered words, the phoneme series and the feature vector series were memorized in the feature vector buffer 97, the ID of that N numbers of unregistered words, the phoneme series, the cluster numbers, representative member ID and scores are registered.

Then, when the ID of new unregistered word, the phoneme series, and the feature vector series are newly memorized in the feature vector buffer 97, the score sheet will be updated in the clustering unit 98 as shown by the dotted lines in FIG. 21.

More specifically, IDs of new unregistered words, the phoneme series, cluster numbers, representative member ID, and the score to each of the memorized unregistered words related to new unregistered words (s (N+1, 1), s (2, N+1), . . . s (N+1, N) in FIG. 19) will be added. Moreover, the score to the new unregistered word relating respectively to the memorized unregistered words (s (N+1, 1), s (2, N+1), . . . s (N+1, N) in FIG. 21) will be added to the score sheet. Furthermore, the unregistered word cluster number and the representative member ID in the score sheet will be changed as occasion demands and these will be described later.

According to the embodiment of FIG. 21, the score to the unregistered word (phoneme series) having the ID i on the unregistered word (speech) having the ID i is shown as s(i, j).

Furthermore, in the score sheet (FIG. 21), the score s(i, j) to the unregistered word (phoneme series) with the ID i on the unregistered word (speech) with the ID i will be registered. However, since this score s(i, j) will be calculated in the matching unit 92 when the phoneme series of the unregistered word is detected, it is not necessary to calculate in the clustering unit 98.

Again, returning to FIG. 17, the maintenance unit 100 updates the word dictionary memorized in the dictionary memory unit 94 based on the score sheet updated at the score sheet memory unit 99.

At this point, the representative member of the cluster will be determined as follows. For example, of unregistered words that become members of the cluster, the word that makes the sum of scores (or such as the mean value that the sum is divided by the number of other unregistered words, may be used) on each of other unregistered words the maximum becomes the representative member of that cluster. Thus, in this case, where the member ID of the member belonging to the cluster is expressed by k, the member having the ID value k (∈k) becomes the representative member as shown in the following Expression:

K=maxₖ{Σs(k³,k)} (1)

Provided that max k { } means k to make the value in { } to the maximum value. Moreover, k3 means ID of the member that belongs to the cluster the same as k. Furthermore, Σ means the sum after k3 being changed over all Ids of members that belong to the cluster.

In the case of determining the representative member as described above, if the cluster member is one or two unregistered words, it is not necessary to calculate the score in determining the representative member. More specifically, in the case where the cluster member is one unregistered word, that one unregistered word becomes the representative member, and in the case where the cluster member is two unregistered words, either one of two unregistered words may become the representative member.

Moreover, the method to determine the representative member is not limited to the method mentioned above. But also it is possible to make the member that makes the sum of distance in the feature vector space with other unregistered words the smallest as the representative member of that cluster in the unregistered words that become members of that cluster.

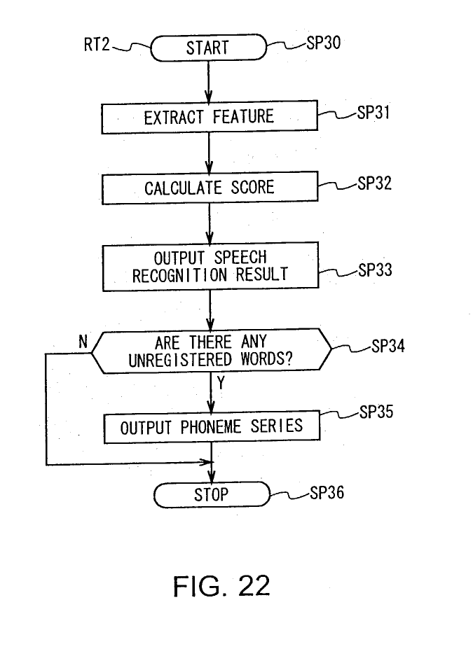

In the speech recognition unit 80 constructed as described above, the speech recognition process for recognizing the speech entered into the microphone 51 and the unregistered word processing will be conducted according to the speech recognition processing procedure RT2 shown in FIG. 22.

In practice, in the speech recognition unit 80, when the audio signal S1B obtained through the speech by the human being is given to the feature extraction unit 91 after being converted to audio data via the AD converter 90 from the microphone 51, the speech recognition processing procedure RT2 will be started at the step SP30.

At the following step SP31, the feature extraction unit 91 extracts the feature vector by conducting the acoustic analysis onto that audio data per the predetermined frame, and supplies that feature vector series to the matching unit 92 and the unregistered word section processing unit 96.

At the following step SP32, the matching unit 92 conducts the score calculation onto the feature vector series from the feature extraction unit 91. Then, at the step SP33, the matching unit 92 outputs this based on the score obtained as a result of score calculation seeking for the title of word series to become the speech recognition result.

Furthermore, at the following step SP34, the matching unit 92 judges whether any unregistered words are contained in the user's voice or not.

At the step SP34, if it is judged that the unregistered word is not contained in the user's voice, that is, the case where the speech recognition result is obtained without said rule for unregistered word “$pat1=$color1 $garbage $color2;” is applied, proceeding to the step SP35, the processing will be terminated.

On the other hand, at the step SP34, if it is judged that the unregistered word is contained in the user's voice, that is, the case where the rule of unregistered word “$pat1=$color1 $garbage $color2;” is applied and the speech recognition result is obtained, the matching unit 92 detects the speech section corresponding to the variable $garbage of the unregistered word rule as the speech section of unregistered words, and also detects the phoneme series as the phoneme transition in the garbage model showing that variable $garbage as the phoneme series of unregistered words, and supplies that speech section of unregistered words and the phoneme series to the unregistered word section processing unit 96 and terminates the processing (step SP36).

On the other hand, the unregistered word section processing unit 96 temporarily memorizes the feature vector series to be supplied from the feature extraction unit 91, and when the speech section of unregistered words and the phoneme series are supplied from the matching unit 92, it detects the feature vector series of speech in that speech section. Furthermore, the unregistered word section processing unit 96 attaches ID to the unregistered word (phoneme series) from the matching unit 92, and supplies this with the phoneme series of unregistered words and the feature vector series over that speech section to the feature vector buffer 97.

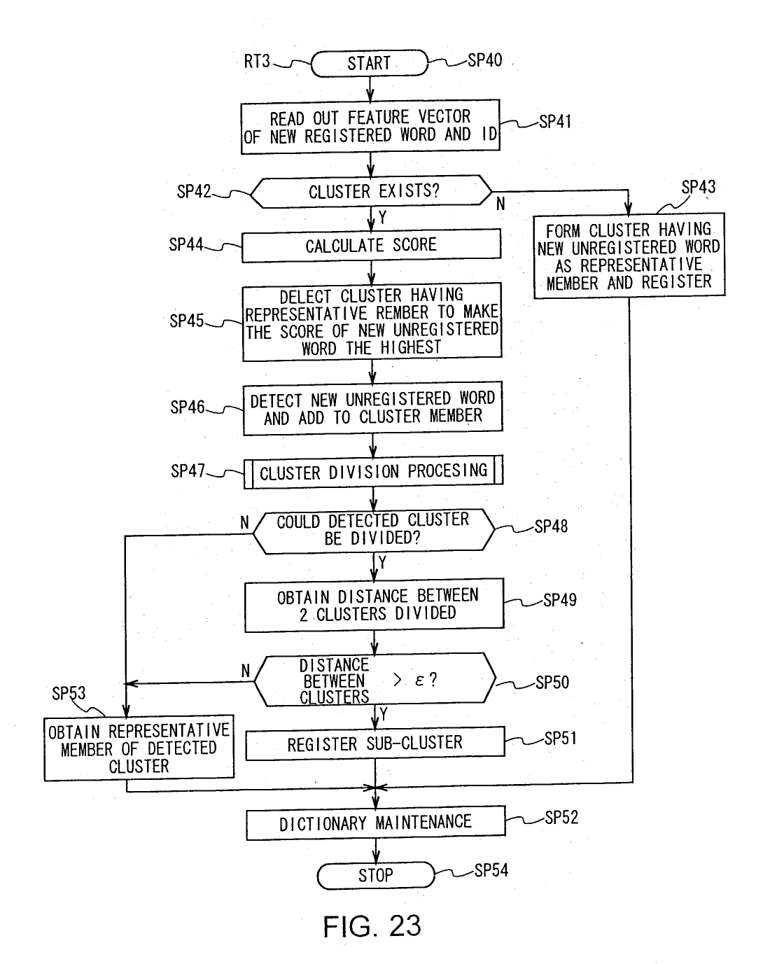

With this arrangement, if the ID of new unregistered word, the phoneme series and the feature vector series are memorized in the feature vector buffer 97, the processing of unregistered words will be conducted according to the unregistered word processing procedure RT3 shown in FIG. 23.

In the speech recognition unit 80, when the ID of new unregistered word, the phoneme series and the feature vector series are memorized in the feature vector buffer 97 as described above, said unregistered word processing procedure RT3 is started at the step SP40. And firstly, at the step SP41, the clustering unit 98 reads out the ID of new unregistered word and the phoneme series from the feature vector buffer 97.

Then, at the step SP42, the clustering unit 98 judges if the cluster already obtained (formed) exists or not by referring to the score sheet of the score sheet memory unit 99.

Then, at the step SP42, if it is judged that there exists no cluster obtained, i.e., the case where the new unregistered word is a virgin unregistered word and there exists no entry of memorized unregistered word in the score sheet, proceeding to the step SP43, the clustering unit 98 forms new cluster making that new unregistered word as the representative member. And by registering the information on that new cluster and the information on that new unregistered word on the score sheet of the score sheet memory unit 99, it updates the score sheet.

More specifically, the clustering unit 98 registers the ID and the phoneme series of new unregistered word read out from the feature vector buffer 97 on the score sheet (FIG. 21). Moreover, the clustering unit 98 forms the unique cluster number and registers this as the cluster number of new unregistered word on the score sheet. Also, the clustering unit 98 registers the ID of the new unregistered word on the score sheet as the representative number ID of that new unregistered word. Thus, in this case the new unregistered word becomes a new cluster representative member.

However, in the above case, since there exists no memorized unregistered word to calculate the score with the new unregistered word, the score calculation will not be conducted.

After the processing of step SP43, proceeding to the step SP52, the maintenance unit 100 updates the word dictionary of the dictionary memory unit 94 based on the score sheet updated at the step SP43 and terminates the processing (step SP54).

More specifically, since the new cluster is formed in this case, the maintenance unit 100 refers to the cluster number in the score sheet and identifies the cluster newly formed. Then, the maintenance unit 100 adds the entry corresponding to that cluster to the word dictionary of the dictionary memory unit 94, and registers the phoneme series of the new cluster of representative member, i.e., in this case, the phoneme series of new unregistered word, as the phoneme series of that entry.

On the other hand, in the case where it is judged that the cluster already obtained exists, i.e., the case where the new unregistered word is not a virgin unregistered word, and thus, the entry (line) of memorized unregistered word exists in the score sheet (FIG. 21), proceeding to the step SP44, the clustering unit 98 calculates the score on the new unregistered word regarding each of memorized unregistered words and simultaneously, it calculates the score on each memorized unregistered word with respect to the new unregistered word.

For example, presently the memorized unregistered word having the ID of 1−N numbers exists, and where the ID of the new unregistered word to be N+1, in the clustering unit 98, the score s (N+1, 1), s (N+1, 2) . . . , s (N, N+1) to each of N numbers of memorized unregistered words regarding the new unregistered words of the part shown by the dotted line in FIG. 21, and scores s (1, N+1), s (2, N+1) . . . s (N, N+1) to the new unregistered words on each of N numbers of memorized unregistered words can be calculated. In calculating these scores in the clustering unit 98, it becomes necessary to have feature vector series of the new unregistered word and N numbers of memorized unregistered words. However, these feature vector series can be identified by referring to the feature vector buffer 97.

Then, the clustering unit 98 adds the calculated score to the score sheet with the ID of new unregistered words and the phoneme series and proceeds to the step SP45.

At the step SP45, the clustering unit 98 detects the cluster having the representative member that makes the score on the new unregistered word s (N+1, i) (i=1, 2, . . . , N) the maximum by referring to the score sheet (FIG. 21). More precisely, the clustering unit 98 identifies the memorized unregistered word that become the representative member by referring to the representative member ID if the score sheet, and by referring to the score of the score sheet, it detects the memorized unregistered word as the representative member that can make the score on the new unregistered word the maximum. Then, the clustering unit 98 detects the cluster of the cluster number of memorized unregistered word as said detected representative member.

Then, proceeding to the step SP46, the clustering unit 98 adds the new unregistered word to the member of the cluster detected (hereinafter referred to as detected cluster) at the step SP45. More specifically, the clustering unit 98 records the cluster number of the representative member of the detected cluster as the cluster number of new unregistered word on the score sheet.

Then, the clustering unit 98 conducts the cluster division processing to divide the detected cluster such as into two clusters at the step SP47, and proceeds to the step SP48. At the step SP48, the clustering unit 98 judges whether the detected cluster is divided into 2 clusters or not by the cluster division processing at the step SP47, and if it judges that the cluster has been divided into two, proceeds to the step SP49. At the step SP49, the clustering unit 98 obtains the distance between two clusters (hereinafter referred to as the first sub-cluster and the second sub-cluster) obtained by dividing the detected cluster.

Here, the distance between the first sub-cluster and the second sub-cluster will be defined as follows:

Where the ID of both optional members (unregistered word) of the first sub-cluster and the second sub-cluster to be expressed by k; and the ID of representative member (unregistered word) of the first and the second sub-clusters to be expressed by k1 and k2 respectively; the value D (k1, k2) expressed by the following Expression will be the distance between the first and the second sub-clusters.

D(k1,k2)=maxva1ₖ{abs(log(s(k,k1))−log(s(k,k2)))} (2)

Provided that in EXPRESSION (2), abs ( ) shows the absolute value in ( ). Also, maxval k { } shows the maximum value of the value in { } to be obtained by changing k. And log shows the natural logarithm or the common logarithm.

Now, if the member having the ID i would be expressed as the member #1, the reciprocal 1/s (k, k1) of the score in Expression (2) is equivalent to the distance between the member #k and the representative member k1, and the reciprocal of the score 1/s (i, k2) is equivalent to the distance between the member #k and the representative member k2. Therefore, according to Expression (2), of the first and the second sub-cluster members, the maximum value of the difference of the distance between the first sub-cluster representative member #k1 and the second sub-cluster representative member #k2 becomes the distance between the first sub-cluster and the second sub-cluster.

In this connection, the distance between clusters will not limited to the case described above. But also such as conducting the DP matching between the first sub-cluster representative member and the second sub-cluster representative member, the summated value of the distance in the feature vector space can be regarded as the distance between clusters.

After the processing of the step SP49, the clustering unit 98 proceeds to the step SP50 and judges whether the distance between the first and the second sub-clusters is larger than the predetermined threshold value τ or not.

At the step SP50, in the case where the distance between clusters is larger than the predetermined threshold value τ, i.e., the case where the plural number of unregistered words as the detected cluster members can be considered that these should be clustered into two clusters based on the acoustic feature, proceeding to the step SP51, the clustering unit 98 registers the first and the second sub-clusters on the score sheet of the score sheet memory unit 99.

More specifically, the clustering unit 98 allocates unique cluster numbers to the first sub-cluster and the second sub-cluster, and updates the score sheet so that the cluster number clustered to the first sub-cluster becomes the cluster number of the first sub-cluster and the cluster number clustered to the second sub-cluster becomes the cluster number of the second sub-cluster in the detected cluster members.

Furthermore, the clustering unit 98 updates the score sheet so that the representative member ID of the member clustered to the first sub-cluster becomes the representative member ID of the first sub-cluster and simultaneously, the representative member ID of the member clustered to the second sub-cluster becomes the representative member ID of the second sub-cluster.

In this connection, it is possible to allocate the cluster number of the detected cluster to one of clusters, the first sub-cluster or the second sub-cluster.

When the clustering unit 98 registers the first and the second sub-clusters on the score sheet as described above, it proceeds to the step SP52 from the step SP51. The maintenance unit 100 updates the word dictionary of the dictionary memory unit 94 based on the score sheet and terminates the processing (step SP54).

In this case, since the detected cluster is divided into the first and the second sub-clusters, the maintenance unit 100 firstly eliminates the entry corresponding to the detected cluster in the word dictionary. Moreover, the maintenance unit 100 adds two entries corresponding respectively to the first and the second sub-clusters to the word dictionary, and registers the phoneme series of the representative member of the first sub-cluster as the phoneme series of entry corresponding to the first sub-cluster and simultaneously it registers the phoneme series of the representative member of the second sub-cluster as the phoneme series of entry corresponding to the second sub-cluster.

On the other hand, at the step SP48 if it is judged that the detected cluster could not be divided into two clusters by the cluster division processing of the step SP47, or at the step SP50, if it is judged that the distance between clusters of the first sub-cluster and the second sub-cluster is not larger than the predetermined threshold value τ, proceeding to the step SP53, the clustering unit 98 seeks for new representative member of the detected cluster and updates the score sheet.

More specifically, the clustering unit 98, referring to the score sheet of the score sheet memory unit 99, identifies the score s (k3, k) required for calculating the Expression (1) on each member of the detected cluster to which new unregistered word is added as the member. Moreover, the clustering unit 98 obtains ID of the member to become new representative member of the detected cluster based on the Expression (1) using that identified score s (k3, k). Then, the clustering unit 98 rewrites the representative member ID of each member of the detected cluster in the score sheet (FIG. 21) to new representative member ID of the detected cluster.

Then, proceeding to the step SP52, the maintenance unit 100 updates the word dictionary of the dictionary memory unit 94 based on the score sheet and stops the processing (step SP54).

In this case, the maintenance unit 100 identifies new representative member of the detected cluster by referring to the score sheet and also identifies the phoneme series of that representative member. Then, the maintenance unit 100 changes the phoneme series of entry corresponding to the detected cluster in the word dictionary to the phoneme series of new representative member of the detected cluster.

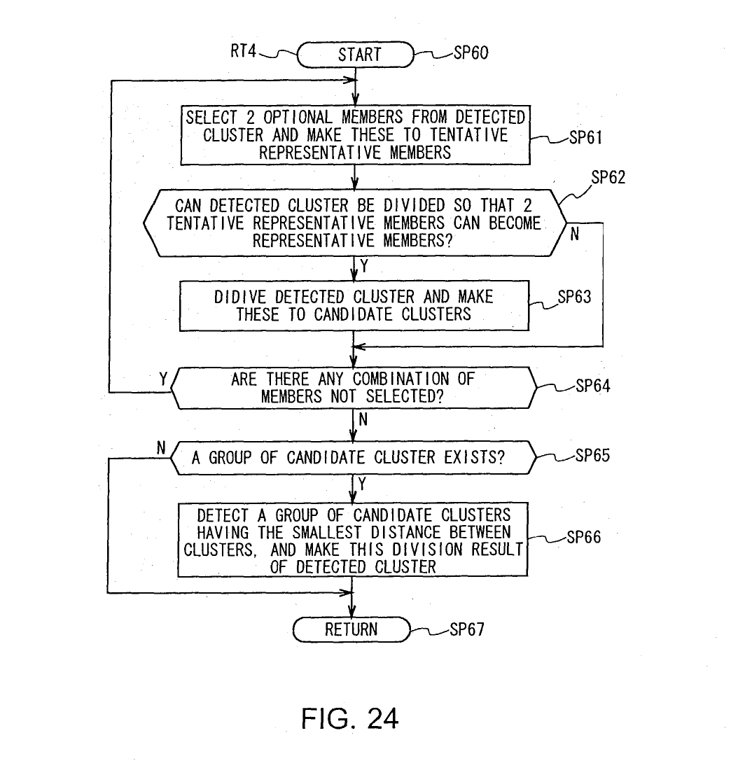

At this point, the cluster division processing of the step SP4 of FIG. 23 will be conducted according to the cluster division processing procedure RT4 shown in FIG. 24.

More specifically, the speech recognition unit 80, after proceeding to the step SP47 from the step SP46 of FIG. 24, starts this cluster division processing procedure RT4 at the step SP60. Firstly, at the step SP61, the clustering unit 98 selects the combination of optional 2 members not yet selected from the detected cluster to which new unregistered word is added as the member and makes these as tentative representative members. And hereinafter two tentative representative members are referred to as the first tentative representative member and the second tentative representative member.

Then, at the following step SP62, the clustering unit 98 judges whether the detected cluster member can be divided into two clusters so that the first tentative representative member and the second tentative representative member can become representative members respectively.

At this point, regarding whether the first or the second tentative representative member can be included as the representative member or not, it is necessary to conduct the calculation of Expression (1), and the score s (k′, k) to be used in this calculation can be identified by referring to the score sheet.

At the step SP62, in the case where it is judged that the detected cluster member cannot be divided into two clusters in order that the first tentative representative member and the second tentative representative member can become representative members respectively, the clustering unit 98 skips the step SP62 and proceeds to the step SP64.

Furthermore, at the step SP62, if it is judged that the detected cluster can be divided into two clusters in order that the first tentative representative member and the second tentative representative member can become representative members respectively, the clustering unit 98 proceeds to the step SP63. Then, the clustering unit 98 divides the detected cluster member into 2 clusters so that the first tentative representative member and the second tentative representative member can become the representative members respectively, and making that divided 2 cluster groups as the first and the second sub-cluster candidates (hereinafter referred to as candidate cluster group) to become the division result of the detected cluster, proceeds to the step SP64.

At the step SP64, the clustering unit 98 judges whether there exist two member groups which are not yet selected as the first and the second tentative representative member group in the detected cluster members or not. And if it judges that there exist such groups, returning to the step SP61, selects two member groups of the detected cluster not yet selected as the first and the second tentative representative member group, and repeats the same processing.

Furthermore, at the step SP64, if it is judged that there is no two member groups of the detected cluster which is not selected as the first and the second tentative representative member group, proceeding to the step SP65, the clustering unit 98 judges whether the candidate cluster group exists or not.

At the step SP65, if it is judged that there exists no candidate cluster group, the clustering unit 98 skips the step SP66 and returns. In this case, it is judged that the detected cluster could not be divided at the step SP48 of FIG. 23.

On the other hand, at the step SP65, in the case where it is judged that the candidate cluster group exists, the clustering unit 98 proceeds to the step SP66, and if the plural number of candidate cluster groups exist, it obtains the distance between two clusters of each candidate cluster group. Then, the clustering unit 98 obtains the candidate cluster group having the shortest distance between clusters. And as a result of dividing the detected cluster, the clustering unit 98 makes that candidate cluster group as the first and the second sub-clusters, and returns. In this connection, if only one candidate cluster group exists, that candidate cluster group is regarded as the first and the second sub-cluster as it is.

In this case, it is judged that the detected cluster can be divided at the step SP48 of FIG. 23.

As described above, in the clustering unit 98, since the cluster (the detected cluster) to which new unregistered word is added as the new member is detected from clusters in which already obtained unregistered word is clustered and the detected cluster is to be divided based on that detected cluster member making said new unregistered word as the new member of that detected cluster, the new unregistered words having closely resemble acoustic features each other can be easily clustered.

Furthermore, in the maintenance unit 100, since the word dictionary is updated based on said clustering result, the registration of unregistered words to the word dictionary can be easily conducted preventing the word dictionary from becoming large-scaled.

Furthermore, even if the matching unit 92 made mistake in detecting the speech section of unregistered word, such unregistered words will be clustered into the cluster other than the unregistered word of which the speech section could be detected correctly by dividing the detected cluster. Then, the entry corresponding to such cluster will be registered in the word dictionary. However, since the phoneme series of this entry corresponds to the speech section not correctly detected, it is not necessary to give the large score in the speech recognition. Accordingly, if the detection between the speech section of unregistered word would be mistaken, that error would have no effect on the speech recognition thereafter.

At this point, FIG. 25 shows the clustering result obtained by uttering the unregistered word. In FIG. 25, each entry (each line) shows one cluster. Moreover, the left column of FIG. 25 shows the phoneme series of representative member (unregistered word) of each cluster, and the right column of FIG. 25 shows the speech contents and the numbers of the unregistered words that become members of each cluster.

More specifically, in FIG. 25, such as the entry of the first line shows the cluster in which only one speech of the unregistered word “furo” becomes the member, and the phoneme series of its representative member becomes “doroa:”. Moreover, the entry of the second line shows the cluster in which 3 utterances of the unregistered word “furo” become members, and the phoneme series of that representative member become “kuro”.

Furthermore, the entry of the seventh line shows the cluster in which 4 utterances of the unregistered word “hon” is the member, and the phoneme series of its representative member is “NhoNde:su”. Moreover, such as the entry of the eighth line. shows the cluster in which one utterance of the unregistered word “orange” and 19 utterances of the unregistered word “hon” become members, and the phoneme of that representative member becomes “ohoN”. The same applies to other entries.

It is clear from FIG. 25 that the speech of the same unregistered word is clustered satisfactorily.

In the 8^{th} line entry of FIG. 25, one utterance of the unregistered word “orange” and 19 utterances of the unregistered word “hon” are clustered in the same cluster. It is considered that this cluster should become the cluster of the unregistered word “hon” from the utterance to which this cluster belongs, however, the utterance of the unregistered word “orange” also becomes that cluster member. However, as the utterance of unregistered word “hon” is entered further, it is considered that the cluster will be divided into the cluster that makes only the utterance of unregistered word “hon” as the member and the cluster that makes only the utterance of unregistered word “orange” as the member.

(6) Dialogue between User and Robot using Dialogue Control System

(6-1) Acquisition and Offer of Content Data on Word-Game

In practice, according to the dialogue control system 63 shown in FIG. 6, in the case where the user conducts a dialogue by playing on words with the robot 1, the robot 1 obtains the content data showing the detailed content of the word game (such as “riddle”) from the database in the content server 61 in response to the request from the user and can utter the question based on said content data to the user.

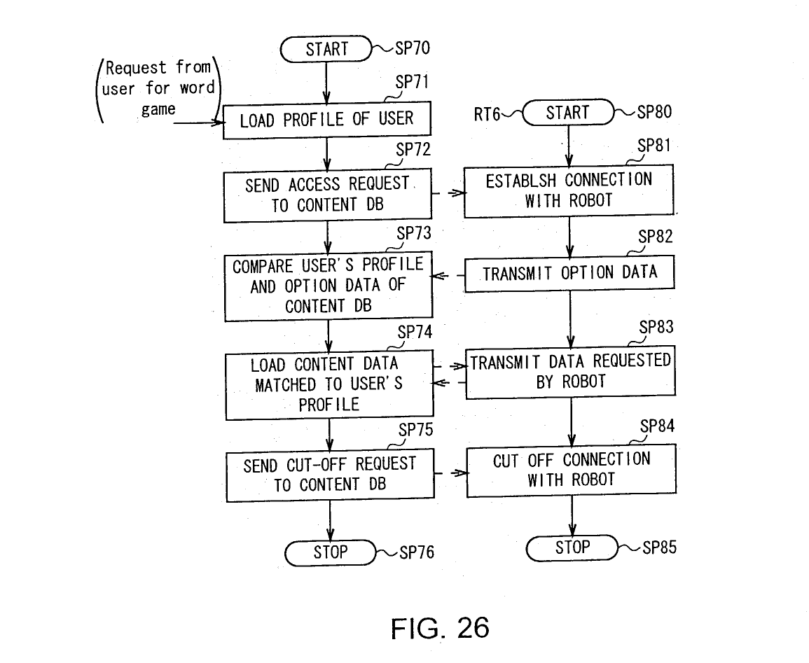

In this interactive system, when the robot 1 collects sounds of utterance from the user such as “Let's play a riddle”, via the speaker 54, it starts the content data acquisition processing procedure RT5 shown in FIG. 26 from the step SP70. And at the following step SP71, after conducting the speech recognition processing onto the user's utterance content, it reads out the profile data formed corresponding to each user from the memory 40A in the main control unit 40 and loads.

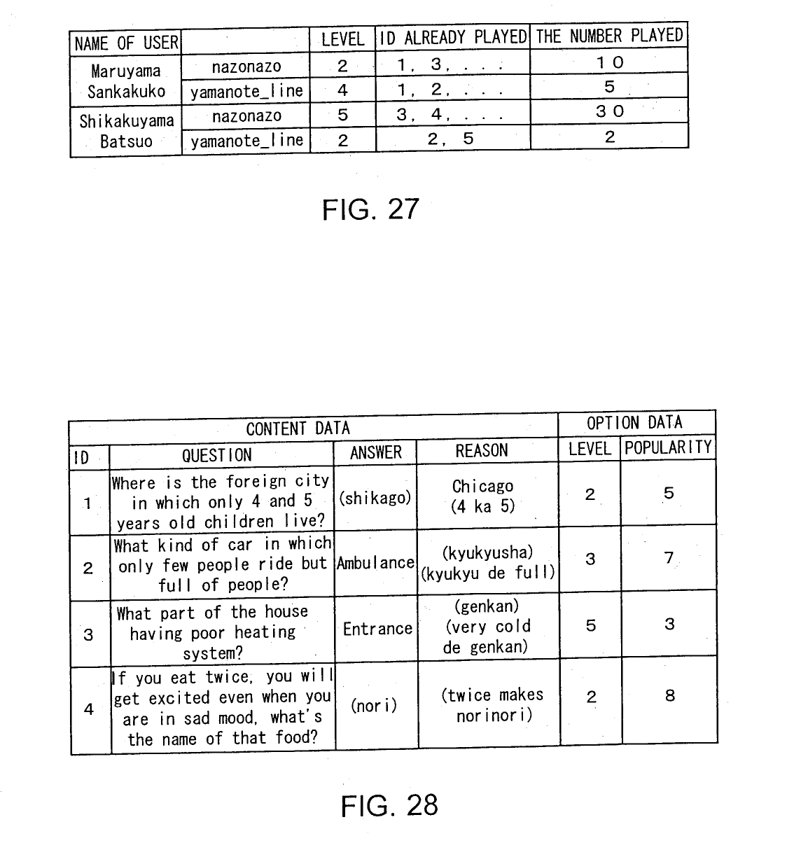

Such profile data is stored in the memory 40A of the main control unit 40, and as shown in FIG. 27, the type of word game conducted by each user is described in this profile data, also the difficulty (level) of each question, ID already played and the number of games already played are described in said profile data according to said type of word game.

More specifically, regarding the user having the user name “Maruyama Sankakuko ”, re “nazonazo” in the word game, the level is “2”, already played ID is “1, 3, . . . ” and the number played is “10”; re “Yamanote-line game”, the level is “4”, already played ID is “1, 2, . . . ” and the number played is “5”. And regarding the user having the user name “Shikakuyama Batsuo”, re “nazonazo” in the word game, the level is “5”, already played ID is “3, 4, . . . ”, and the number played is “30”; re “Yamanote-line game”, the level is “2”, already played ID is “2, 5, . . . ”, and the number played is “2”.

Then, this profile data is transmitted to the content server 61 and will be updated as occasion demands by being returned from said content server 61. More precisely, regarding “nazonazo” in the word game, if the correct answer is obtained, the level is increased, and if it is not popular, it is judged that is the question not interesting, and the profile data will be updated omitting that type of question.

Then, the robot 1, after transmitting the data requesting “nazonazo” in the word game to the content server 61 via the network 62 at the step SP72, proceeds to the step SP73.

When the content server 61 receives the request data from the robot 1, starts the content data offering processing procedure RT6 from the step SP80, and at the following step SP81, the content server 61 establishes the communicatable state between said robot 1.

Here, in the database in the content server 61, content data is formed in each type of word game (such as “nazonazo” and “Yamanote-line game”, etc.), and multiple question contents set corresponding to that type are attached with ID number and described in said content data.

For example, as shown in FIG. 28, regarding “nazonazo” in the word game, four questions to which ID numbers are allocated sequentially (hereinafter referred to as 1^{st}-4^{th} question contents ID1-ID4) are described. And questions and answers to said questions, and the reasons for said questions are sequentially described in these contents of the 1^{st}—the 4^{th} questions ID1-ID4.

Firstly, the first question content ID1 is described as: the question is “Where is the foreign city in which only 4 and 5 years old children live?”, the answer is “Chicago”; and the reason is “4 years or 5 years means shi or go (Chi(four) ca(or) go(five) in Japanese). Moreover, in the second question content ID2 is described as: “What kind of car in which only few people ride but full of people?”, the answer is “Ambulance”; the reason is “the car is full because of kyukyu” (“kyukyu” means “full” in Japanese, and “kyukyu car” means “ambulance” in Japanese). Furthermore, the third question content ID3 is described as: the question is “What part of the house having the poor heating?”, the answer is “entrance”; and the reason is “genkan”, (“genkan” means both “very cold” and “entrance” in Japanese). Furthermore, the fourth question content ID4 is described as: the question is “If you eat twice, you will get excited even when you are in sad mood?, what's the name of that food?”; the answer is “seaweed”; and the reason is “become norinori (seaweed) if you eat twice.” (“nori” means “seaweed” and “norinori” means “excited” in Japanese).

The option data to be set corresponding to the type of word game is attached to the content data, and the popularity degree according to the difficulty and the number of times that question is used is converted into the number and described corresponding to the 1^{st}-4^{th} question contents ID1-ID4. And the content of this option data will be updated based on the number of accessing from the robot 1 and the user's answer result as necessary.

Then, the content server 61, after transmitting the option data added to the content data regarding “nazonazo (riddle)” to the robot 1, proceeds to the step SP83.

Then, when the robot 1 receives the option data transmitted from the content server 61 at the step SP73, compares said option data with the profile data corresponding to the user. And the robot 1 selects the question content best suited to the user concerned from the content data, and transmits the data requesting said question content to the content server 61 via the network 62.

More specifically, as shown in FIG. 27, in the case where the user having the name such as “Maruyama Sankakuko” is playing “nazonazo” (riddle) in the word game, the robot 1 transmits the profile data on this user, and requests the content data showing the question content corresponding to the level “2” of “nazonazo” based on said profile data.

At the step SP83, the content server 61 reads out the corresponding content data from the database based on the data transmitted from the robot 1, and transmitting this to the robot 1 via the network 62, it proceeds to the step SP84.

More specifically, in the case where the level of “nazonazo” in the profile data obtained from the robot 1 shows the level “2”, the content server 61 selects the question to match that level, i.e., the content data showing the question content corresponding to the level “2” in the option data shown in FIG. 28 and transmits to the robot 1. In this case, the first and the fourth question contents ID1 and ID4 in the content data are applicable. However, since already played ID in the user name “Maruyama Sankakuko” contains “1”, the content server 61 transmits the fourth question content ID4 (not yet played) to the robot 1.

Then, at the step SP74, after loading the content data obtained from the content server 61, the robot 1 proceeds to the step SP75, and transmits the data showing a cut-off request of the communication link to the content server 61 via the network 62. Then, proceeding to the step SP76, the robot 1 terminates said content data acquisition processing procedure RT5.

On the other hand, at the step SP84, the content server 61 cuts off the communication link established between said robot 1 based on the data transmitted from the robot 1, and proceeding to the step SP85, it terminates said content data offering processing procedure RT6.

Thus, in the content data acquisition processing procedure RT5, if the specific type of word game such as “nazonazo” is specified by the user in the case of playing on words with the user, the robot 1 can obtain the question content best suited to the user from multiple question contents forming said type through the content server 61.

Furthermore, according to the content data offering processing procedure RT6, the content server 61 can select the content data containing the question content best suited to the user out of multiple content data stored in the database responding to the request from the robot 1, and can provide to the robot 1.

(6-2) Dialogue Sequence according to Word Game between Robot and User

At this point, in the memory 40A of the main control unit 40 of the robot 1, in the case of conducting the conversation between the robot 1 and the user according to the word game, the interactive mode showing the exchange of conversation between the robot 1 and the user is determined in advance. And thus, if the type of word game is the same, such as a new different question content can be offered to the user by only changing the content data based on said interactive model.

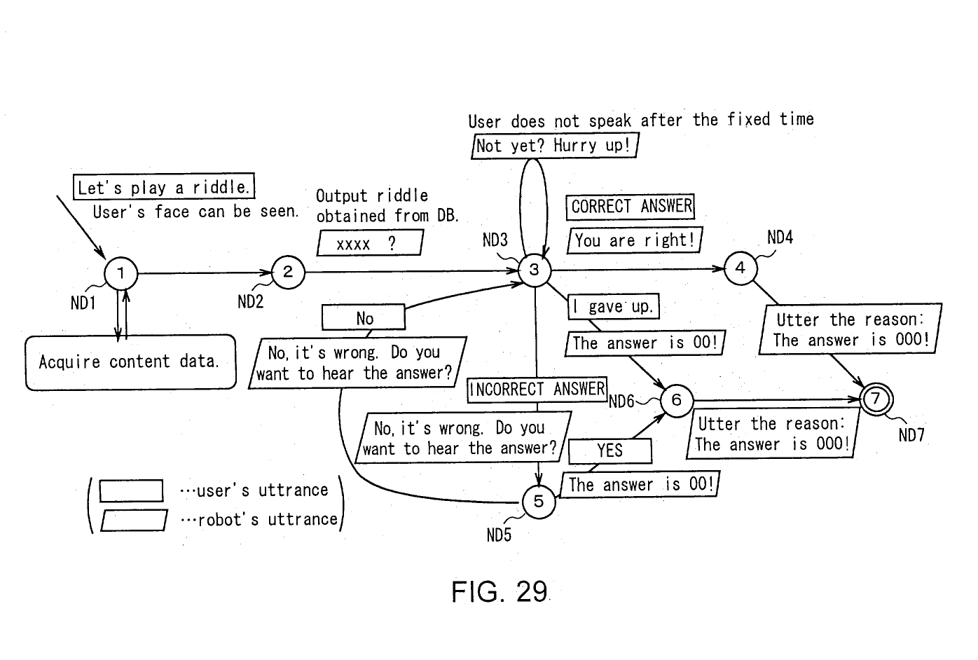

In practice, when the robot 1 receives the utterance from the user informing that playing on words, as shown in FIG. 29, the main control unit 40 of the robot 1 successively determines the next speech content by the robot 1 when speaking with the user based on the interactive model corresponding to the type of this word game.

In such interactive model, utterances that the robot 1 can make are taken to be nodes NDB1-NDB7 respectively, these transition-capable nodes are connected by the directed arc showing the utterance, and the directive graph expressing the utterance to be completed between one node will be used.

Thus, in the memory 40A the file in which all utterances that said robot 1 can utter are put in database is stored, and the directed graph will be formed based on this file.

When the main control unit 40 of the robot 1 receives the utterance from the user informing that he is conducting the word game, using the corresponding directed graph and following the direction of the directed arc, searches for the channel to the directed arc to which the utterance specified from the present node or to the self action arc, and sequentially outputs directions to conduct the utterances corresponded respectively to each directed arc on the channel detected.

The case where the dialogue by “nazonazo” (riddle) is actually conducted between the user and the robot 1 will be explained. Firstly, the robot 1 obtains the content data showing the question content such as “Where is the foreign city in which only 4 or 5 years old children live?” from the content server 61 (Node ND1), and utters said question content to the user (Node ND2).

Then, the robot 1 waits for the answer from the user (Node ND3), and if the user's answer is correct “shi ka go” (Chicago), the robot 1 utters “atari!” (you've won) (Node ND4) and utters its reason “4 to 5 de shikago (Chicago)” (Node ND7).

Furthermore, if the user's answer is not correct, the robot 1 utters “No, it's wrong. Do you want to hear the answer?” (Node ND5) and further utters its reason “4 to 5 de shikago” (Node ND7). Moreover, if no answer is received after the given period of time has passed, the robot 1 utters “Oh, no, not yet?” (Node ND3) and further encourages the answer from the user.

Thus, as the answer related to the dialogue between the robot 1 and the user, by uttering the reason of correct answer not only telling the correct answer, the amusingness when playing “nazonazo” (riddle) with the robot 1 can be increased.

Furthermore, since the robot 1 utters the reason for correct answer, the user can know that even if the robot 1 misrecognized the user's utterance content.

This is a game, and it is not especially necessary for the user to correct the speech recognition error of the robot 1. However, in the case where the robot 1 misrecognized the user's speech content, the game of playing on words can be conducted smoothly by informing that error indirectly to the user.

(6-3) Renewal of Option Data

In the dialogue control system 63 shown in FIG. 6, as described in the content data acquisition processing procedure RT5 and the content data offering processing procedure RT6 (FIG. 26), when the robot 1 obtains the content data from the content server 61, the information concerning which data the robot 1 obtained will be reflected to the option data added to that content data.

For example, the popularity data value to become the index what type of word games and how many times of what kind of question content the robot 1 obtained will be changed.

Furthermore, when the robot 1 sets the question of word game to the user, the data whether the user answers correctly or not to that question content will be sent back to the content server 61 via the network 62, and its value will be updated so that it reflects to the difficulty level of said question.

Thus, feedback from the robot 1 to the database in the content server 61 may be conducted automatically by the robot 1 without the user being aware of it. However, the feedback to the content server 61 may be obtained directly from the user according to the conversation with the robot 1.

At this point, in the content server 61, the case to update the option data added to the content data based on the content data sent back from the robot 1 will be explained.

When the robot 1 obtains the content data from the content server 61, the information which data is obtained will be reflected to the option data added to that content data.

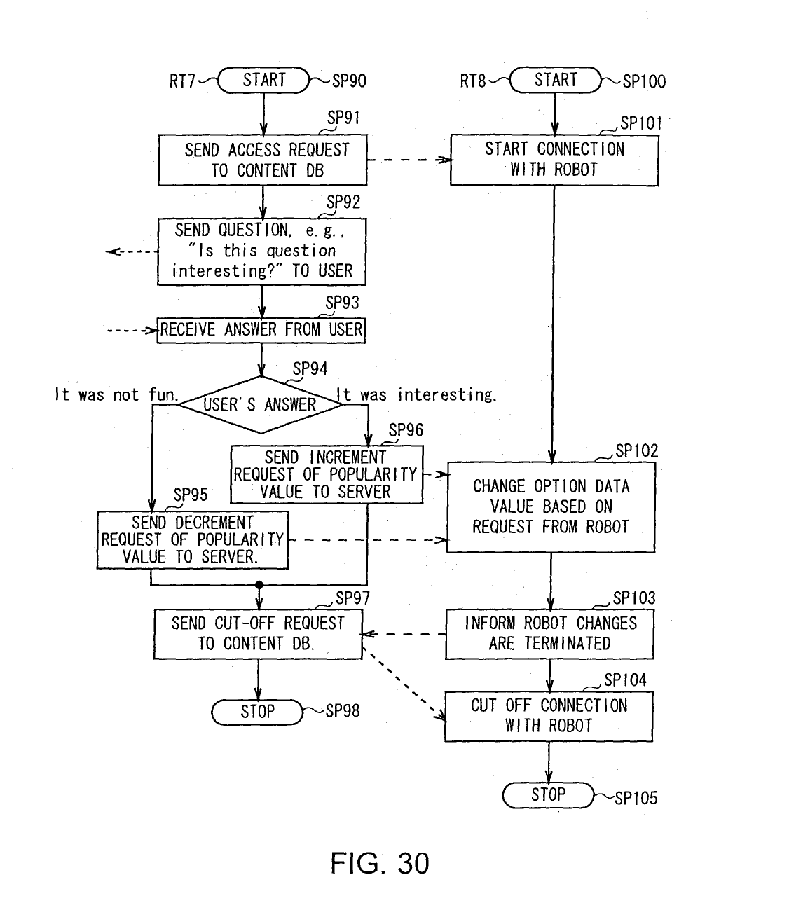

In practice, in the dialogue control system 63 shown in FIG. 6, after the user conducts the conversation by playing on words between the robot 1, the robot 1 updates the popularity index automatically or determines responding to utterance from the user, starts the popularity index collection processing procedure RT7 shown in FIG. 30 from the step SP90. Then, at the following step SP91, the robot 1 transmits the data showing an access request to the content server 61.

When the content server 61 receives the request data from the robot 1, starts the option data updating processing procedure RT8 from the step SP100, and at the following step SP101, it establishes the communicatable state between the robot 1.

Then, the robot 1 proceeds to the step SP92, and after uttering the question such as “Is this question interesting?”, proceeds to the step SP93.

At this step SP93, after waiting for an answer from the user, the robot 1 proceeds to the step SP94 when it receives said answer. At the step SP94, the robot 1 judges the answer content from the user meaning whether “It was boring”, or “It was fun”. And if it judges that “It wasn't fun”, proceeds to the step SP95, and after transmitting the request data requesting to decrement the popularity level value to the content server 61 via the network 62, proceeds to the step SP97.

On the other hand, at the step SP94, if the robot 1 judges that the content of answer from the user means “It was fun”, proceeds to the step SP96, and after transmitting the request data requesting to increment the popularity level value to the content server 61 via the network 62, proceeds to the step SP97.

The content server 61, after reading out the option data added to the corresponding content data from the database based on the request data from the robot 1, decrements or increments the value of “popularity” of the description contents of said option data.

Then, at the step SP103, the content server 61 transmits the answer data informing that updating of the option data is terminated to the robot 1 via the network 62, and proceeds to the step SP104.

The robot 1, after confirming that the option data has been updated based on the answer data transmitted from the content server 61, transmits the request data showing a cut-off request of communication state to the content server 61, and proceeding to the step SP98 as it is, terminates said popularity index collection processing procedure RT7.

At the step SP104, the content server 61 cuts off the communication state established between said robot 1 based on the request data transmitted from the robot 1, and proceeding to the step SP105, it terminates said option data updating processing procedure RT8.

With this arrangement, in the popularity index collection processing procedure RT7, the robot 1 can confirm the existence or non-existence of popularity of that question by asking the user whether it is interesting or not on the question content based on the content data proposed to the user.

Furthermore, in the option data updating processing procedure RT8, by updating the description contents of the option data added to said content data based on the existence or non-existence of popularity on the question content based on the content data obtained from the robot 1, the user can reflect the amusingness of said question contents and the preferences to the next time.

(6-4) Registration of Content Data

There are two ways to register the content data registered according to each type of word games store in the database in the content server 61; the case where each user indirectly makes the content server 61 register the question content and its answer and the reason for that answer (hereinafter referred to merely as question contents) based on the content data via the robot 1 by uttering these, and the case where each user directly makes the content server register these using his own terminal but not through the robot 1. And each of these cases will be explained hereunder.

(6-4-1) Case of Registering Question Contents Indirectly Via Robot

In the dialogue control system 63 shown in FIG. 6, the robot 1, after receiving the question contents by the user's utterance, transmitting said question contents to the content server 61 via the network 62, registers this on the database in said content data additionally.

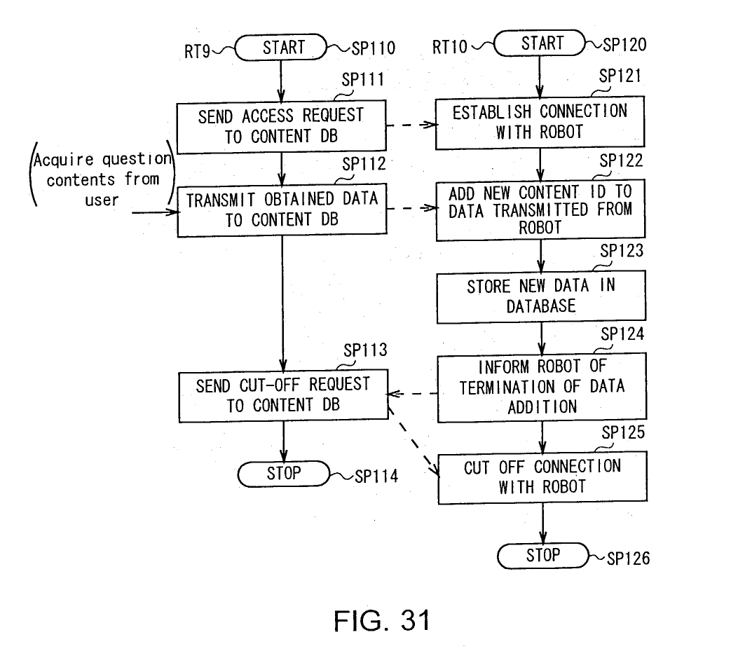

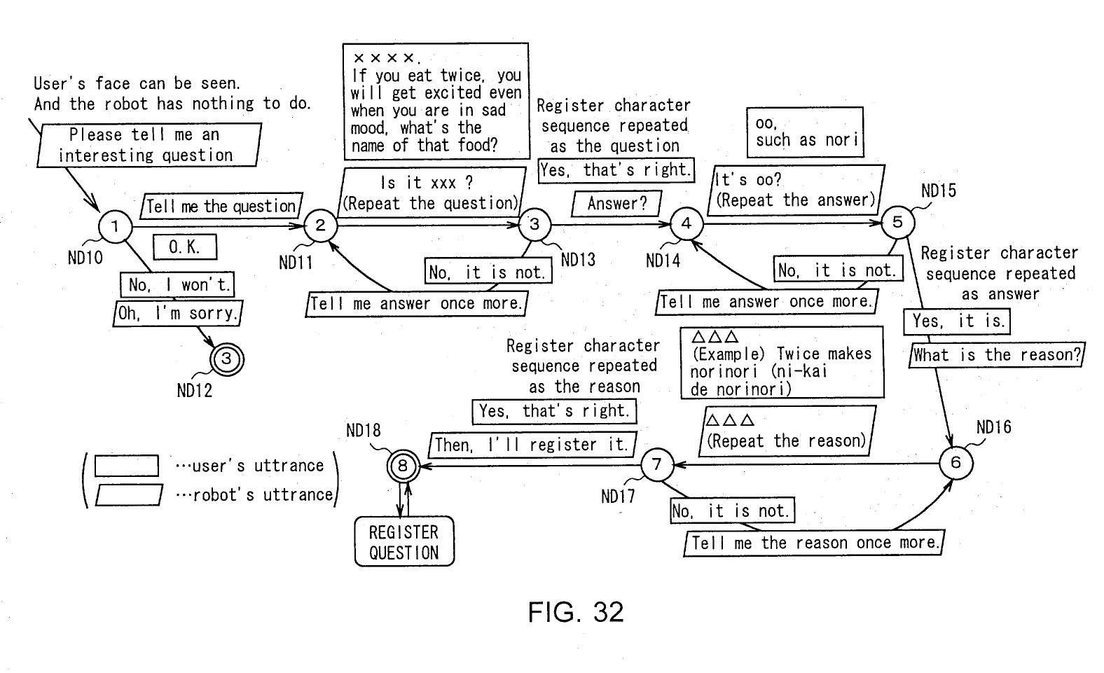

In this dialogue control system 63, when the robot 1 collects sounds showing new question contents from the user, starts the content collection processing procedure RT9 shown in FIG. 31 from the step SP110, and at the step SP111, it transmits a request data showing the access request to the content server 61.

Then, when the content server 61 receives the request data from the robot 1, it starts the content data adding registration processing procedure RT10 from the step SP120. And at the step SP121, the content server 61 establishes the communicatable state between said robot 1.

Then, the robot 1, after transmitting the obtained data showing the question contents obtained from the user to the content server 61 via the network 62, proceeds to the step SP113.

At the step SP122, the content server 61 allocates the ID number to said data obtained as the content data based on the obtained data transmitted from the robot 1 and proceeds to the step SP123.

At this step SP123, the content server 61 registers the question contents to which said ID number is allocated on the storage position corresponding to said user and corresponding to the type of word game in the database. As a result, the question content of the N (N is the natural number) 1DN will be added and described in the database.

Then, the content server 61, after transmitting the answer data informing that the addition and registration of content data have been completed to the robot 1 via the network, proceeds to the step SP125.

The robot 1, after confirming that the content data has been added and registered based on the answer data transmitted from the content server 61, transmits the request data showing the cut-off request of the communication state to said content server 61 via the network 62, proceeds to the step SP114 as it is, and terminates said content collection processing procedure RT9.

At the step SP125, the content server 61, after cutting off the communication state established between the robot 1 based on the request data transmitted from the robot 1, proceeds to the step SP126 and terminates said content data adding registration processing procedure RT10.

Thus, in the content data collection processing procedure RT9, the robot 1 can add and register new question contents uttered from the user in the database of the content server 61 as the content data related to that user.

Furthermore, in the content data adding registration processing procedure RT10, by registering said question contents adding to said contents related to that user as the content data, the amusingness can be further increased not only to said user but also to other users because the type of contents has been increased.

Thus, the user who uttered new question contents can know to what degree the question contents that he proposed is being used by other users by accessing to the content server 61 and reading out the option data stored in the database.

When the robot 1 actually receives the question contents by the user's utterance by using said interactive model, as shown in FIG. 31, the main control unit 40 of the robot 1 successively determines the utterance contents by the next robot 1 when speaking with the user based on the interactive model corresponding to the word game type.

Firstly, the robot 1 utters “Please tell me an interesting question” to the user. Then, the robot 1 waits for the answer from the user (Node ND10), and if the answer from the user is “OK”, after uttering “Tell me the question” (Node ND11), waits for the answer from the user.

On the other hand, if the utterance from the user is “No, I won't”, the robot 1, after uttering “Oh, I'm sorry to hear that” (Node ND12), terminates such dialogue sequence.

When the robot 1 receives the utterance from the user as the question such as “If you eat twice, you will get excited even when you are in sad mood, what's the name of that food?”, it utters that speech recognition result (word of question) repeatedly (Node ND13).

In the case where the user utters “That's right” after hearing said utterance, the robot 1 utters “What's the answer?” requesting the answer to that question (Node ND14). On the other hand, in the case where the user says “It's wrong”, the robot 1 utters “Tell me again that question” requesting that question again (Node ND11).

Then, if the robot 1 receives the answer “nori (seaweed)” from the user, it repeatedly utters that speech recognition result (word of the answer) (Node ND15). And in the case where the user says “That's right” upon hearing Robot's utterance, the robot 1 utters “What's the reason?” requesting the reason for that answer, while in the case where the user utters “It's wrong”, the robot 1 utters “Please say that answer again” requesting the answer again (Node ND14).

Then, when the robot 1 receives the utterance “Twice makes norinori” from the user as the reason for that question, it repeatedly utters that speech recognition result (word of reason) (Node ND17). In the case where the user utters “That's right” upon hearing said utterance, the robot 1 utters “Then, I'll register this” (Node ND18). While if the user utters “It's wrong”, the robot 1 utters “Please tell that reason again” requesting the reason again (Node ND16).

Then, the robot 1 adds and registers the question and its answer and the reason for that answer obtained from the user into the database in the content server 61 via the network as the content data.

Thus, the robot 1 can provide a larger quantity of contents than before to the user by adding and registering the question contents newly obtained from the user as the content data to the description content concerning that user.

(6-4-2) Case of Correcting Question Contents Directly without through Robot

Furthermore, in the dialogue control system 63 shown in FIG. 6, there is a case where the reason for the answer to said question in the question contents formed by the user does not make sense as the answer related to the user's utterance, and there is a case where the question in said question contents is too difficult and no one can answer, after the user making the robot 1 register new question contents in the database in the content server 61 via the robot 1.

In these cases, the user accessing to the content server 61 via the network 62 by using the terminal device such as his own personal computer, can correct the description contents of the corresponding content data in the database.

More specifically, concerning the question contents registered by the user, in the case where the question is “If you eat twice, you will get excited even when you are in sad mood, what's the name of that food?”, and the reason to that answer “nori” is “If you eat twice, you will get excited”, the answer “nori” cannot be brought up.

Thus, when the content server 61 receives the feedback such as “I don't understand the reason well” from the user, the user accesses to the database using his own terminal device, and by changing the reason in the question contents based on said content data to “Nikai de norinori dayo” (twice makes excited), can correct said content data.

In this connection, the correction of content data may be conducted not only by the user who can access to the database but also by the manager of database. Furthermore, the content data may be updated not only partially but also the whole content data may be reformed.

(7) Operation and Effects of the Present Embodiment

According to the foregoing construction, in this dialogue control system 63, in the case of conducting the conversation by playing on words between the robot 1 and the user, when the type of word game (such as riddles) is specified by the user, the robot 1 reads out the profile data on said user and transmits to the content server 61 via the network 62.

The content server 61, after selecting the content data containing question contents best suited to the user from multiple content data stored in the database based on the profile data received from the robot 1, can provide said content data to the robot 1.

In the case where the robot 1 and the user are playing on words, since the robot l describes the reason for the answer after the user answers to the question content uttered by the robot 1, not only the conversation itself appears intelligent and it can become very interesting, but also the robot 1 can show the user how the robot 1 recognized. And if the user's utterance is the same as the robot 1, it can give the user the feeling of security, while the user's utterance is different from his, the robot 1 can make the user recognize that point.

Since the robot 1 does not confirm the use's utterance contents one by one, the flow and rhythm of the conversation with the user would not be stopped, and the natural daily conversation as if the fellow men are talking each other can be realized.

Moreover, in the dialogue control system 63, the robot 1 asks the user whether the question content based on the content data that the user proposed is interesting or not, and since its result is returned to the content server, said content server can make the statistical evaluation on the popularity of that question contents.

Moreover, since based on the statistical evaluation on that question content, the content server updates the description contents of the option data added to the content data, the amusingness and liking of that question contents can be reflected not only to said user but also to other users in the next time.

Furthermore, in the dialogue control system 63, since the robot 1 transmits the question contents newly obtained from the user to the content server and said content server adds and registers these onto the database, more contents can be provided to the user and the conversation with the robot 1 can be widely prevailed without making the user get tired of it.

According to the foregoing construction, since in this dialogue control system 63, in the case of conducting the conversation by playing on words between the robot 1 and the user, if the user specifies the type of word game (such as riddle), the robot 1 transmits the profile data on said user, and said content server 61 selects the content data containing the question contents best suited to the user from the database and provides to the robot 1, the amusingness can be given to the conversation with the robot 1. Thereby, the entertainment factor can be remarkably increased.

(8) Other Embodiments

The embodiment described above has dealt with the case of applying the present invention to a two-leg walking robot 1 constructed as shown in FIGS. 1-3. However, the present invention is not only limited to this but also can be widely applied to such as the four-leg walking robot and other pet robots having various other shapes.

Furthermore, the embodiment described above has dealt with the case of applying the main control unit 40 (dialogue control unit 82) in the body unit 2 of the robot 1 which is equipped with the function to interact with the man as the interactive means to recognize the utterance of the user. However, the present invention is not only limited to this but also it may be widely applicable to the interactive means having various other constructions.

Furthermore, according to the embodiment described above, in the robot 1, the case of forming the forming means for forming the profile data (history data) regarding the word game out of the user's speech contents, and the updating means for updating said profile data (history data) corresponding to the user's speech content to be obtained through the word game, as well as storing the profile data (history data) in the memory 40A of the main control unit 40 have been described. However, the present invention is not only limited to this but also it may be widely applicable to the forming means and the updating means having various other constructions regardless these are united in one or separated.

Furthermore, the embodiment described above has dealt with the case of applying the “riddle” and “Yamanote-line game” as the word game. However, in addition to these, the present invention is widely applicable to such as cap verses, joke, make puns, anagram and gabble (twisting tongue), in short, various games utilizing pronunciation, rhythm and meaning of word.

Furthermore, the embodiment described above has dealt with the case of applying the Wireless Communication Standard compatible wireless LAN card (not shown in Fig.) equipped in the body unit 2 as the.communication means for transmitting the history data to the content server (information processing device) via the network when starting the word game in the robot 1. However, the present invention is not only limited to other wireless communication circuit net but also is applicable to the wired communication circuit net such as the general public circuit and LAN.

Furthermore, the embodiment described above has dealt with the case of applying the database stored in the hard disk device 68 in the content server 61 as the memory means for memorizing content data showing contents of multiple word games in the content server (information processing device) 61. However, the present invention is not only limited to this, but also it may be widely applicable to the memory means having various constructions provided that content data can be database controlled so that the plural number of robots can use these in common as required.

Furthermore, the embodiment described above has dealt with the case of applying CPU 65 as the detection means for detecting the profile data (history data) transmitted from the robot 1 via the network 62 in the content server (information processing device) However, the present invention is not only limited to this but also it is applicable to the detection means having various other constructions.

Furthermore, the embodiment described above has dealt with the case of applying CPU 65 and the network interface unit 69 as the communication control means for transmitting the former robot 1 via the network 62 after selectively reading out the content data from the database (storage means) based on the detected profile data (history data) in the content server (information processing device). However, the present invention is not only limited to this but also it is applicable to the communication control means having various other constructions.

Furthermore, according to the embodiment described above, in the robot 1, after the robot 1 recognizing the evaluation related to contents of word games based on the content data output to the user from said user's utterance, updates the profile data (history data) according to the evaluation and transmits said updated profile data to the content server 61; in the content server (information processing device) 61, the content server 61, memorizing the option data added to the content data of the word game corresponding to said content data, updates the data part related to the evaluation based on the profile data on the option data added to the content data selected. However, the present invention is not only limited to this but also in short, if the amusingness and the liking of the content data for said user and also to other users can be reflected to the next time by updating the option data, the other data may be used as the content data, and various other methods may be used as the updating method.

Moreover, according to the embodiment described above, after the robot 1 recognizes contents of a new word game output to the user from said user's utterance, transmits new content data showing the contents of word game to the content server 61. Then, the content server 61 adds the content data on the corresponding user and memorizes the new content data in the database. However, the present invention is not only limited to this, but also in short, providing more contents to the user if the conversation with the robot can be widely spread not making the user get tired, the other method may be used as the new content data adding method.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. A dialogue control system in which a robot and an information processing device are connected via network, wherein:
said robot comprising:
interactive means for interacting with the human beings and recognizing the utterance of the user to become the object through the conversation;
forming means for forming a history data related to the word games out of said user's speech contents by said interactive means;
updating means for updating said history data formed by said forming means corresponding to said user's speech contents to be obtained through said word games; and
communication means for transmitting said history data to said information processing device via the network in the case of starting said word games; and
said information processing device comprising:
memory means for memorizing content data showing the contents of a plurality of said word games;
detection means for detecting said history data transmitted via said communication means; and
communication control means for selectively reading out said content data from said memory means based on said history data detected by said detection means and for transmitting to the original said robot via the network, wherein
said interactive means of said robot outputs contents of said word games based on said content data transmitted from the communication control means of said information processing device.

2. The dialogue control system according to claim 1, wherein:
in said robot,
said interactive means recognizes the evaluation related to the content of said word games based on said content data put out to said user from said user's utterance;
said updating means updates said history data corresponding to said evaluation;
said communication means transmits said history data updated by said updating means to said information processing device; and
in said information processing device;
said memory means memorizes annex data accompanying said content data of said word games connected to said content data; and
said communication control means updates data part relating to the evaluation based on said history data transmitted from said communication means on said annex data accompanying to said selected content data.

3. The dialogue control system according to claim 1, wherein:
in said robot,
said interactive means recognizes contents of a new word game put out to said user from said user's utterance; and
said communication means transmits new content data showing contents of said word game to said information processing device; and
in said information processing device,
said memory means memorizes said new content data transmitted from said communication means after adding to said content data concerning said corresponding user.

4. The dialogue control system according to claim 1, wherein
said memory means is database that can be owned jointly by the plural number of said robots.

5. A dialogue control method in which a robot and an information processing device are connected via network, comprising:
a first step in said robot, for recognizing targeted user's utterance through the conversation with the human beings, forming history data related to word games out of said user's speech contents, and updating and transmitting said formed history data corresponding to said user's speech contents to be obtained through said word games to said information processing device via said network in the case of starting said word games;
a second step in said information processing device, for reading out said content data selected based on said history data transmitted from said robot out of content data showing said contents of the plural number of said word games memorized in advance and for transmitting to the said original robot via said network; and
a third step in said robot, for outputting contents of said word games based on said content data transmitted from said information processing device.

6. The dialogue control method according to claim 5, wherein:
at said first step,
after identifying the evaluation related to the content of said word games based on said content data put out to said user from said user's utterance, said history data is updated according to said evaluation and said updated history data is transmitted to said information processing device; and
at said second step,
annex data accompanying to the content data of said word games is memorized related to said content data, and on said annex data accompanying to said content data selected, and the data part relating to the evaluation based on said history data transmitted is updated.

7. The dialogue control method according to claim 5, wherein:
at said first step, after recognizing contents of a new word game put out to said user, new content data showing contents of said word game is transmitted to said information processing device; and
at said second step, said content data regarding said corresponding user is added, and said new content data transmitted from said communication means is memorized.

8. The dialogue control method according to claim 5, wherein
at said second step, the content data showing the contents of multiple said word games stored in advance is database-controlled so as to be owned by the plural number of said robots.

9. A robotic device connected via an information processing device and the network, comprising:
interactive means for interacting with the human beings and recognizing the utterance of the user to become the object through the conversation;
forming means for forming history data related to word games out of said user's speech contents by said interactive means;
updating means for updating said history data formed by said forming means corresponding to said user's speech contents to be obtained through said word games, wherein
said interactive means outputs the contents of said word games based on said content data, when said content data selected based on said history data transmitted from said communication means are transmitted via said network out of content data showing contents of said multiple word games memorized in advance in said information processing device.

10. The robotic device according to claim 9, wherein:
said interactive means recognizes the evaluation related to the content of said word games based on said content data put out to said user from said user's utterance;
said updating means updates said history data corresponding to said evaluation;
said communication means transmits said history data updated by said updating means to said information processing device; and
in said information processing device, regarding the annex data accompanying to said content data selected out of annex data attached to the content data of said word game memorized in advance and associated with said content data, the data part related to the evaluation based on said history data transmitted from the communication means is updated.

11. The robotic device according to claim 9, wherein:
said interactive means recognizes contents of a new word game output to said user from said user's utterance;
said communication means transmits new content data showing contents of said word game to said information processing device; and
in said information processing device, said new content data transmitted from said communication means is memorized after adding to said content data related to said corresponding user.
